(19) United States
(12) Patent Application Publication
(10) Pub. No.: US 2021/0014276 A1
(43) Pub. Date: Jan. 14, 2021

(54) NETWORK MANAGEMENT APPARATUS, AND NETWORK MANAGEMENT METHOD

(71) Applicant: FUJITSU LIMITED, Kawasaki-shi (JP)

(72) Inventor: Takamichi NISHIJIMA, Kawasaki (JP)

(73) Assignee: FUJITSU LIMITED, Kawasaki-shi (JP)

(21) Appl. No.: 16/921,677

(22) Filed: Jul. 6, 2020

(30) Foreign Application Priority Data
Jul. 12, 2019 (JP) 2019-130381

(51) Int. Cl. H04L 29/06; H04L 12/707

(52) U.S. Cl. CPC H04L 63/20; H04L 45/24; H04L 2463/146; H04L 63/1458; H04L 63/1441

(57) ABSTRACT

The network management apparatus includes a processor coupled to memory and configured to calculate a communication route of traffic that each of a plurality of edge routers transfers to an attack target device that is attacked from outside the network, select a first router where the communication routes of a plurality of flows of traffic that is transferred to the attack target device merge, instruct the first router to restrict transfer of the traffic of the attack, detect a change in traffic of the attack in response to a restriction on transfer of the traffic of the attack, and identify an edge router of an inflow source from a part of the plurality of edge routers or the edge router of the inflow source of the traffic of the attack from rest of the plurality of edge routers.

### CROSS-REFERENCE TO RELATED APPLICATION

This application is based upon and claims the benefit of priority of the prior Japanese Patent Application No. 2019-130381, filed on Jul. 12, 2019, the entire contents of which are incorporated herein by reference.

### FIELD

The embodiments relate to a network management apparatus, and a network management method.

### BACKGROUND

For example, a denial-of-service (DoS) attack is an attack targeting servers in a network. In a DoS attack, a large amount of internet protocol (IP) packets are transmitted to a server as an attack target (hereinafter described as “attack target server”) to thereby cause consumption of resources of the attack target server, and thus the provision of services of the attack target server may be hindered and stopped.

Measures to protect the attack target server from such attacks include a detection device that detects traffic containing IP packets intended for malicious attack (hereinafter described as “attack traffic”) and a protection device such as a firewall that restricts transfer of the attack traffic to the attack target server.

The detection device is connected between the attack target server and the protection device to monitor traffic, and analyzes the amount of traffic and behaviors of the traffic or the like, to thereby determine whether or not the traffic is attack traffic. Thus, the detection device detects attack traffic, and notifies a network management server of information on addresses and ports indicating the destination and source of the attack traffic and on the protocol type of the attack traffic, in addition to a detection notification of the attack traffic.

The management server performs blocking of the attack traffic or setting of a band limitation to the protection device according to the information given in notification from the detection device. Consequently, inflow of the attack traffic to the attack target server is suppressed, and a load on the attack target server is reduced.

Japanese Laid-open Patent Publication No. 2006-67078 is disclosed as related art.

### SUMMARY

According to an aspect of the embodiments, a network management apparatus that manages a network including a plurality of edge routers and a plurality of intermediate routers connected among the plurality of edge routers, the network management apparatus includes a memory and a processor coupled to memory and configured to calculate a communication route of traffic that each of the plurality of edge routers transfers to an attack target device that is attacked from outside the network, select, from the plurality of intermediate routers, a first router where the communication routes of a plurality of flows of traffic that a part of the plurality of edge routers transfer to the attack target device merge, instruct the first router to restrict transfer of the traffic of the attack detect a change in traffic of the attack in response to a restriction on transfer of the traffic of the attack, and identify an edge router of an inflow source from the part of the plurality of edge routers when a change in the traffic of the attack is detected, or identify an edge router of the inflow source of the traffic of the attack from rest of the plurality of edge routers when no change in the traffic of the attack is detected.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram illustrating a network system of a first comparative example;

FIG. 2 is a configuration diagram illustrating a network system of a second comparative example;

FIG. 3 is a configuration diagram illustrating an example of an operation in which a NW management server according to a first embodiment collects route information of traffic addressed to an attack target server;

FIG. 4 is a diagram illustrating an example of an operation in which the NW management server performs restriction setting of traffic on an intermediate router that is a merge destination of communication routes of traffic addressed to an attack target server;

FIG. 5 is a diagram illustrating an example of an operation in which the NW management server lifts block setting on an intermediate router;

FIG. 6 is a diagram illustrating an example of an operation in which the NW management server identifies an inflow source router from an edge router and an edge router of the remaining group;

FIG. 7 is a diagram illustrating an example of an operation when the NW management server has identified the inflow source router;

FIG. 8 is a configuration diagram illustrating an example of the NW management server;

FIG. 9 is a diagram illustrating an example of a tree structure of communication routes described in a route database in a process of identifying the inflow source router;

FIG. 10 is a diagram illustrating an example of the route database, a candidate database, and a setting database in a process of identifying the inflow source router;

FIG. 11 is a flowchart illustrating an example of processing by the NW management server;

FIG. 12 is a diagram illustrating an example of restriction setting in a second embodiment;

FIG. 13 is a diagram illustrating a route database, a candidate database, and a setting database in the second embodiment;

FIG. 14 is a diagram illustrating an example of a process of selecting a setting target router;

FIG. 15 is a flowchart illustrating an example of the process of selecting the setting target router;

FIG. 16 is a diagram illustrating an example of restriction setting in a third embodiment;

FIG. 17 is a diagram illustrating a route database, a candidate database, and a setting database in the third embodiment;

FIG. 18 is a diagram illustrating another example of the process of selecting the setting target router;

FIG. 19 is a flowchart illustrating another example of the process of selecting the setting target router;

FIG. 20 is a configuration diagram illustrating a NW management server according to a fourth embodiment;

FIG. 21 is a diagram illustrating an example of restriction setting in the fourth embodiment;

FIG. 22 is a diagram illustrating the route database and the candidate database after update;

FIG. 23 is a diagram illustrating an example of a process of selecting a first setting target router and a second setting target router;

FIG. 24 is a diagram illustrating an example of upper limit band setting in which upper limit values are different from each other;

FIG. 25 is a flowchart illustrating another example of processing by the NW management server;

FIG. 26 is a diagram illustrating an example in which it is not possible to distinguish and detect influences of the first setting and the second setting;

FIG. 27 is a diagram illustrating an example of restriction setting in the fifth embodiment;

FIG. 28 is a diagram illustrating an example of a case where selection of the first setting target router and the second setting target router is not valid;

FIG. 29 is a diagram illustrating an example of a case where selection of the first setting target router and the second setting target router is valid;

FIG. 30A is a flowchart illustrating another example of processing by the NW management server; and

FIG. 30B is a flowchart illustrating another example of processing by the NW management server.

### DESCRIPTION OF EMBODIMENTS

According to the above method, since attack traffic is not suppressed in a communication route from a device that transmits the attack traffic (hereinafter, described as “attack source device”) to the protection device, the band of other normal traffic may be pressed by the attack traffic, thereby hindering normal communication.

On the other hand, if an edge router that is the inflow source of attack traffic among edge routers located at boundaries with networks that are not managed by the management server suppresses the attack traffic, it is possible to reduce pressure on the band of other traffic. Here, for example, the edge router discards attack traffic by setting and registering address information of the attack traffic in an access control list (ACL), and also by setting the address information of the attack traffic and an upper limit of the band in a policer or a shaper, it is possible to cause the band of the attack traffic to be equal to or less than the upper limit value. Note that the upper limit value is set to a value larger than zero.

However, a router such as the edge router determines a route to a transfer destination of an IP packet by searching a routing table based on the destination address of the IP packet, and thus it is not possible to identify an edge router as an inflow source (hereinafter, described as “inflow source router”) of attack traffic by information such as a transmission source address of the attack traffic.

Thus, for example, if the management server performs the above setting on all edge routers in the network, identification of the inflow source router is not needed, and it is possible to suppress attack traffic without pressing the band of other traffic. However, according to this method, there is a possibility that communication performance of the edge routers is degraded by performing useless setting on each edge router other than the inflow source router.

On the other hand, for example, if the above setting is performed one by one in order on the edge routers in the network unlike the above, it is possible for the management server to identify the inflow source router from a detection result of the detection device, and thus there is no need to perform useless setting on each edge router other than the inflow source router. However, by this method, after having selected the edge routers one by one and performing setting, if this edge router is not the inflow source router, the management server needs to lift the setting, and thus it may take a long time to identify the inflow source router.

Therefore, an object of the embodiments is to provide a network management apparatus, a network management method, and a network management program capable of quickly identifying an edge router as an inflow source of attack.

### Comparative Example

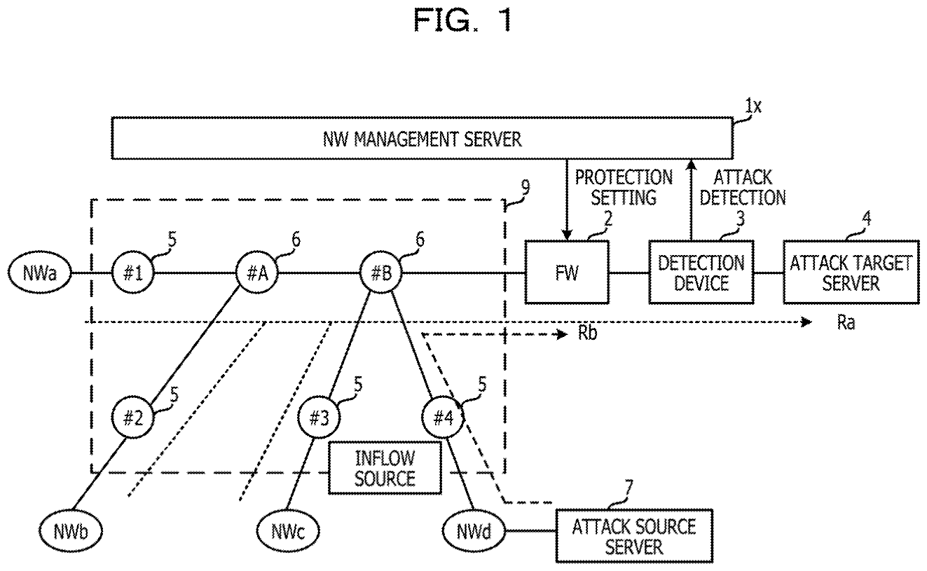

FIG. 1 is a configuration diagram illustrating a network system of a first comparative example. The network system includes a network (NW) management server 1x such as a network element (NE)-operation system (Op), a firewall 2, a detection device 3, an attack target server 4, and a network 9.

The NW management server 1x is, for example, a server such as NE-OpS and manages the network 9. The network 9 includes a plurality of edge routers 5 arranged at boundaries between the network 9 and external networks NWa to NWd, and a plurality of intermediate routers 6 connected among the edge routers 5. The NW management server 1x communicates with each edge router 5 and each intermediate router 6 via another network for management (not illustrated).

For example, router IDs “#1” to “#4” are assigned to the edge routers 5 as identifiers. Furthermore, for example, router IDs “#A” and “#B” are assigned to the intermediate routers 6 as identifiers. In the following description, for example, the edge router 5 with the identifier “#1” is described as “edge router (#1)”, and the intermediate router 6 with the identifier “#A” is described as “intermediate router (#A)”. Note that each intermediate router 6 is a core router for example, but is not limited to this.

The intermediate router (#B) 6 is adjacent to the intermediate router (#A) 6, the edge router (#3) 5, and the edge router (#4) 5, and the intermediate router (#A) 6 is adjacent to the edge router (#1) 5 and edge router (#2) 5. Furthermore, the edge router (#1) 5 to the edge router (#4) 5 are connected to the external networks NWa to NWd, respectively. Here, an attack source server 7 that attacks the attack target server 4 is connected to the external network NWd as an example. Note that the attack target server 4 is an example of an attack target device being attacked.

The firewall 2 is connected between the intermediate router (#B) 6 in the network 9 and the detection device 3. The firewall 2 restricts transfer of attack traffic from the attack source server 7 to the attack target server 4.

The detection device 3 is connected between the firewall 2 and the attack target server 4, and detects attack traffic. The detection device 3 is, for example, a computer on which at least one of software or hardware for monitoring traffic transferred from the network 9 to the attack target server 4 is mounted. The detection device 3 determines whether traffic is attack traffic or not by analyzing the amount of traffic and behaviors of the traffic or the like.

When attack traffic is detected, the detection device 3 notifies the network management server of information on addresses and ports indicating the destination and transmission source of the attack traffic and on the protocol type of the attack traffic (hereinafter, described as “attack information”), in addition to a detection notification of the attack traffic (see “Attack Detection”). Upon receiving a notification of attack detection from the detection device 3, the NW management server 1x performs protection setting against the attack traffic on the firewall 2.

The firewall 2 blocks, for example, attack traffic based on the protection setting. Thus, the attack traffic is transferred from the attack source server 7 to the firewall 2 via the edge router (#4) 5, but does not reach the attack target server 4, as indicated by an arrow Rb. Consequently, inflow of the attack traffic to the attack target server 4 is suppressed, and a load on the attack target server 4 is reduced.

However, the attack traffic is transmitted through a section from the edge router (#4) 5 to the intermediate router (#) 6, and a section from the intermediate router (#B) 6 to the firewall 2. Thus, the bands of normal traffic transferred from the external networks NWa to NWc via the edge router (#1) 5 to the edge router (#3) 5 as indicated by an arrow Ra may be pressed at the intermediate router (#8) 6 by merging with the attack traffic, and normal communication may be interrupted.

On the other hand, if the edge router (#4) 5 (inflow source router) as the inflow source of the attack traffic suppresses the attack traffic, it is possible to reduce the bands of other traffic from being pressed. The edge router 5 and the intermediate router 6, for example, discard attack traffic by registering address information of attack traffic in the ACL, and by setting the address information of attack traffic and an upper limit value of a band in a policer or shaper, it is possible to cause the band of the attack traffic to be equal to or less than the upper limit value. Note that such setting is described as “restriction setting” in the following description.

However, the edge router 5 and the intermediate router 6 determine a route to a transfer destination of an IP packet by searching a routing table based on the destination address of the IP packet, and thus it is not possible to identify the inflow source router by information such as a transmission source address of the attack traffic.

Thus, for example, the NW management server 1x performs restriction setting of attack traffic on all the edge routers 5 in the network.

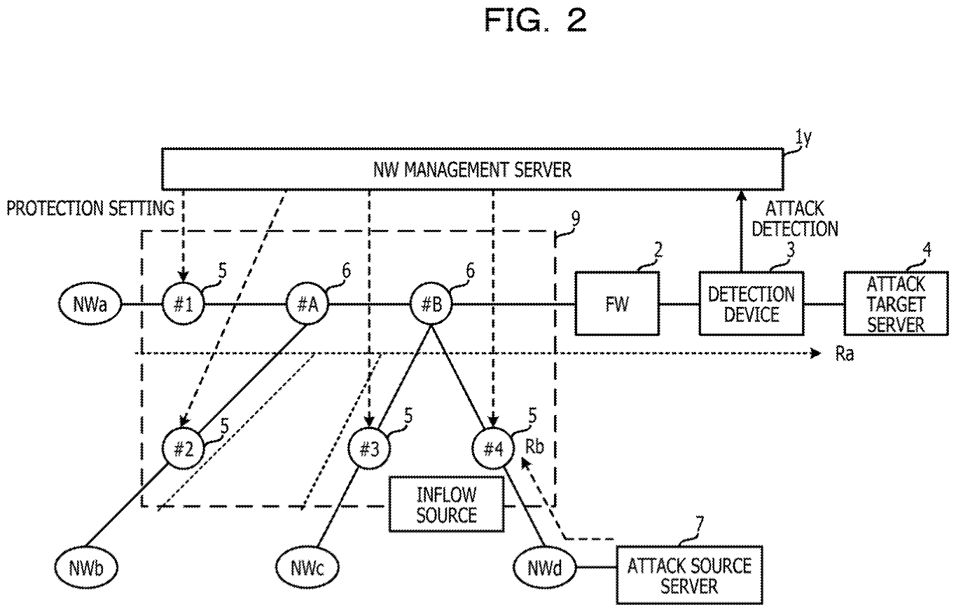

FIG. 2 is a configuration diagram illustrating a network system of a second comparative example. In FIG. 2, components common to FIG. 1 are denoted by the same reference signs, and description thereof will be omitted.

In this example, the NW management server 1y manages the network 9 instead of the NW management server 1x. Upon receiving a detection notification of attack traffic from the detection device 3, the NW management server 1y performs restriction setting of the attack traffic on each edge router 5. Thus, as indicated by an arrow Rb, the attack traffic is restricted from being transferred at the edge router (#4) 5, and does not reach the intermediate router (#B) 6.

Therefore, the NW management server 1y does not need to identify the inflow source router, and may suppress the attack traffic without pressing the band of other traffic.

However, according to this method, there is a possibility that the communication performance of the edge routers is degraded by performing unnecessary restriction setting on the edge router (#1) 5 to the edge router (#3) 5 other than the inflow source router.

On the other hand, for example, the NW management server 1y may identify the inflow source router from a detection result of the detection device 3 by performing the above-described restriction setting one by one in order on the edge routers 5 in the network 9, and thus there is no need to perform useless restriction setting on each edge router 5 other than the inflow source router. However, by this method, after having selected the edge routers 5 one by one and performing setting, if this edge router is not the inflow source router, the NW management server 1y needs to lift the setting, and thus it may take a long time to identify the inflow source router.

Accordingly, the NW management server according to the embodiment calculates a communication route of traffic transferred from each edge router 5 to the attack target server 4, and gives an instruction on restriction of transfer of the attack traffic to the intermediate router 6 where traffic from a part of the edge routers 5 merges. The NW management server identifies the inflow source router from the part of the edge routers 5 when a change in the attack traffic in response to the transfer restriction is detected. The NW management server identifies the inflow source router from rest of the edge routers 5 when no change in the attack traffic is detected.

Therefore, it is possible for the NW management server to narrow down candidates for the inflow source router to either of a part of the edge routers 5 and the other edge routers 5, and thus the inflow source router may be quickly identified with a smaller number of times of restriction setting than in the second comparative example.

When the intermediate router 6 restricts transfer of traffic addressed to the attack target server 4, transfer of a plurality of flows of traffic flowing in from the respective edge routers 5 which are merging sources thereof is collectively restricted. It is possible for the NW management server to determine presence or absence of a change in the attack traffic in response to the transfer restriction, and may determine which of the respective edge routers 5 which are merging sources and the other edge routers 5 include the inflow source router based on a determination result.

Therefore, it is possible for the NW management server to quickly identify the inflow source router with a smaller number of times of restriction setting than in the second comparative example.

### First Embodiment

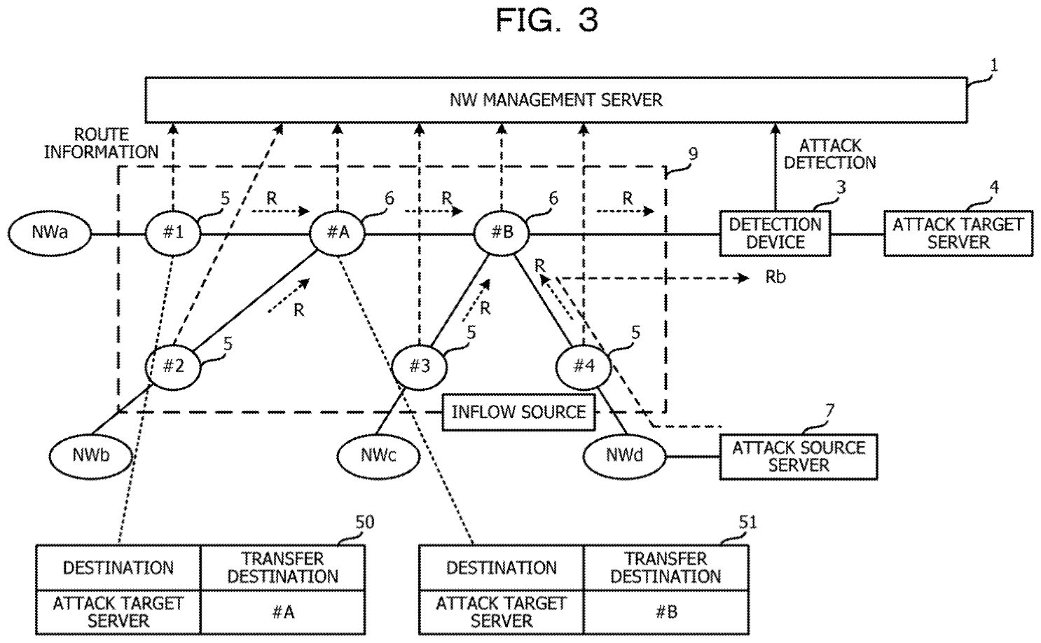

FIG. 3 is a configuration diagram illustrating an example of an operation in which a NW management server 1 of the first embodiment collects route information of traffic addressed to the attack target server 4. In FIG. 3, components common to FIG. 1 are denoted by the same reference signs, and description thereof will be omitted. The NW management server 1 is an example of a network management apparatus that manages the network 9. Note that since the firewall 2 is not used in this example, the illustration thereof is omitted.

Upon receiving a detection notification of attack traffic from the detection device 3, the NW management server 1 calculates a communication route R of traffic that each edge router 5 transfers to the attack target server 4. Thus, for example, the NW management server 1 collects route information from each edge router 5 and each intermediate router 6. The route information is registered in, for example, a routing table of each edge router 5 and each intermediate router 6.

As an example, route information 50 of the edge router (#1) 5 and route information 51 of the intermediate router (#A) 6 are illustrated. Each route information 50, 51 includes an identifier of traffic destination and an identifier of next transfer destination (NEXT HOP). Note that although the route information 50, 51 actually includes IP addresses of a destination and a transfer destination, the NW management server 1 converts the IP addresses into identifiers to manage them, and thus the IP addresses are described here as identifiers.

As the destination of the route information 50, 51, the identifier of the attack target server 4 is registered. The identifier “#A” of the intermediate router (#A) 6 is registered as a transfer destination of the route information 50, and the identifier “#B” of the intermediate router (#B) 6 is registered as a transfer destination of the route information 51.

The edge router (#1) 5 transfers traffic addressed to the attack target server 4 to the intermediate router (#A) 6 as the transfer destination based on the route information 50, and the intermediate router (#A) 6 transfers the traffic addressed to the attack target server 4 to the intermediate router (#B) 6 as the transfer destination based on the route information 51. Here, the destination of traffic is detected, for example, from the destination IP address of an IP packet. Note that the other edge routers 5 and intermediate routers 6 also have route information of traffic addressed to the attack target server 4.

The NW management server 1 calculates a communication route R of traffic addressed to the attack target server 4 based on the route information of each edge router 5 and each intermediate router 6. For example, traffic that the edge router (#1) 5 transfers to the attack target server 4 reaches the attack target server 4 via the intermediate router (#A) 6 and the intermediate router (#B) 6 in this order. Furthermore, for example, traffic that the edge router (#4) 5 transfers to the attack target server 4 reaches the attack target server 4 via the edge router (#4) 5 and the intermediate router (#B) 6 in this order. Note that the NW management server 1 is not limited to the above method, and may calculate the communication route R from route information input by an operator or route information obtained from another database, for example.

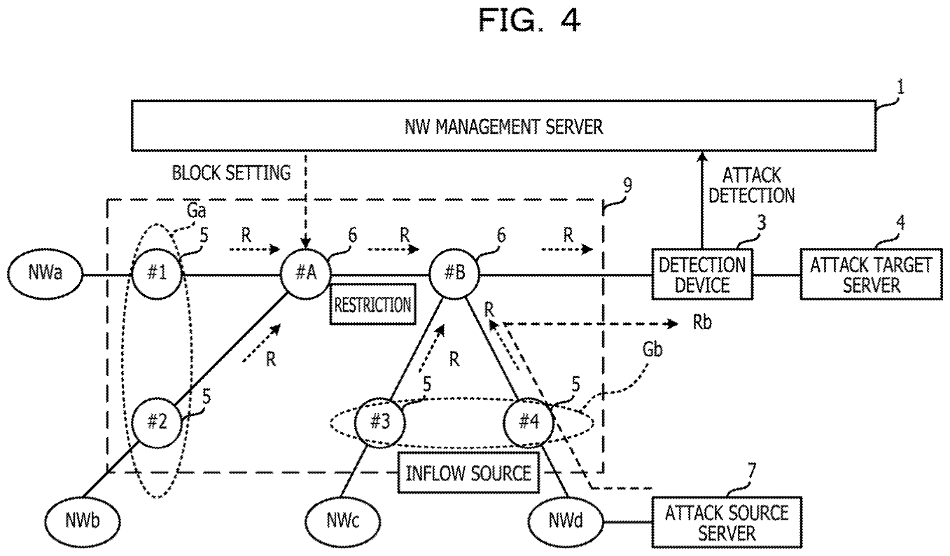

FIG. 4 is a diagram illustrating an example of an operation in which the NW management server 1 performs restriction setting of traffic on the intermediate router (#A) 6 that is a merge destination of communication routes of traffic addressed to the attack target server 4. The NW management server 1 selects an intermediate router 6 that is a merge destination of communication routes R of traffic that a part of the edge routers 5 transfer to the attack target server 4 as a restriction setting target router, out of the intermediate router (#A) 6 and the intermediate router (#B) 6.

In the intermediate router (#B) 6, communication routes R of traffic merge from all of the edge router (#1) 5 to the edge router (#4) 5. Thus, if the NW management server 1 performs restriction setting on the intermediate router (#B) 6, transfer of traffic of all the edge routers 5 is restricted. Thus, even if the detection device 3 detects a change in attack traffic, it is not possible to narrow down candidates for the inflow source router from all the edge routers 5.

On the other hand, in the intermediate router (#A) 6, communication routes R of traffic merge from only a part of the edge routers, the edge router (#1) 5 and the edge router (#2) 5. Thus, when the NW management server 1 performs restriction setting of traffic on the intermediate router (#A) 6, only transfer of traffic from the edge router (#1) 5 and the edge router (#2) 5 upstream of the intermediate router (#A) 6 is restricted among all the edge routers 5.

Thus, when the detection device 3 detects a change in attack traffic, it is possible for the NW management server 1 to narrow down candidates for the inflow source router from all the edge routers 5 to the edge router (#1) 5 and the edge router (#2) 5. Furthermore, when the detection device 3 does not detect a change in attack traffic, the NW management server 1 may narrow down candidates for the inflow source router from all the edge routers 5 to the edge router (#3) 5 and the edge router (#4) 5.

As described above, the NW management server 1 identify the inflow source router by dividing into a group Ga of the edge router (#1) 5 and the edge router (#2) 5 where a merge destination of the communication routes R is the common intermediate router (#A) 6, and a group Gb of the edge router (#3) 5 and the edge router (#4) 5 where a merge destination of the communication routes R is the common intermediate router (#B) 6.

The NW management server 1 performs, on the intermediate router (#A) 6, block setting of traffic addressed to the attack target server 4. At this time, the intermediate router (#A) 6 blocks traffic by setting the ACL according to an instruction from the NW management server 1. Thus, transfer of traffic from the intermediate router (#A) 6 to the intermediate router (#B) 6 is restricted.

However, since the inflow source router is the edge router (#4) 5, the attack traffic is not affected by the block setting, and is continuously transferred to the attack target server 4. Thus, the detection device 3 continues to detect the attack traffic. If the edge router (#1) 5 or the edge router (#2) 5 is the inflow source router, the detection device 3 does not detect the attack traffic because the attack traffic is discarded by the intermediate router (#A) 6 due to the block setting.

The NW management server 1 determines that neither the edge router (#1) 5 nor the edge router (#2) 5 of the group Ga is the inflow source router because no change in the attack traffic is detected, and lifts the block setting on the intermediate router (#A) 6.

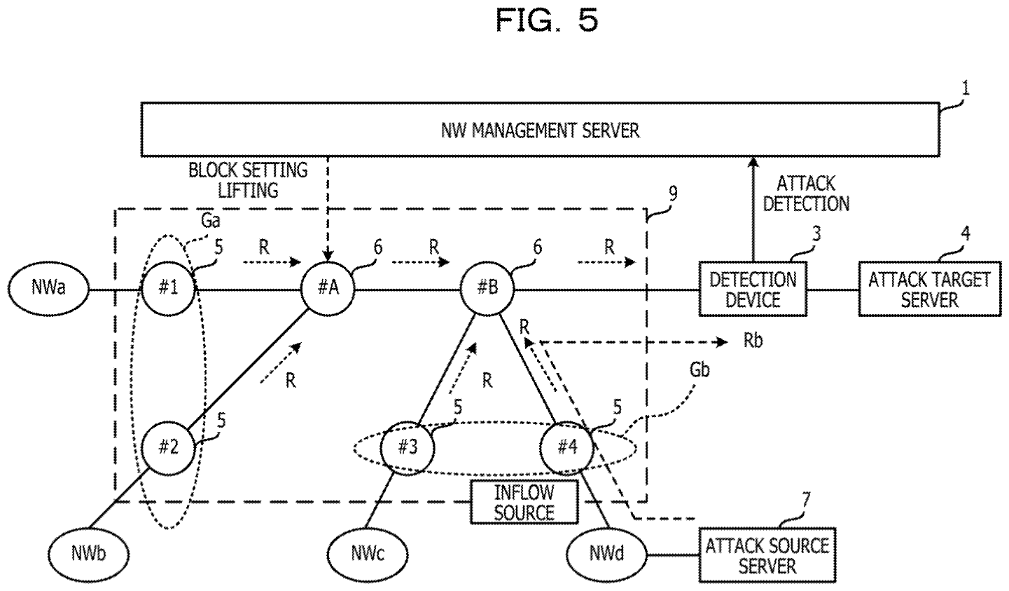

FIG. 5 is a diagram illustrating an example of an operation in which the NW management server 1 lifts the block setting on the intermediate router (#A) 6. In FIG. 5, components common to FIG. 1 are denoted by the same reference signs, and description thereof will be omitted.

The NW management server 1 lifts the block setting of the intermediate router (#A) 6 because reception of the attack traffic detection notification from the detection device 3 continues after the block setting is performed. Thus, transfer of traffic from the edge router (#1) 5 and the edge router (#2) 5 to the attack target server 4 is resumed.

Next, the NW management server 1 identifies the inflow source router from the edge router (#3) 5 and the edge router (#4) 5 of the remaining group Gb.

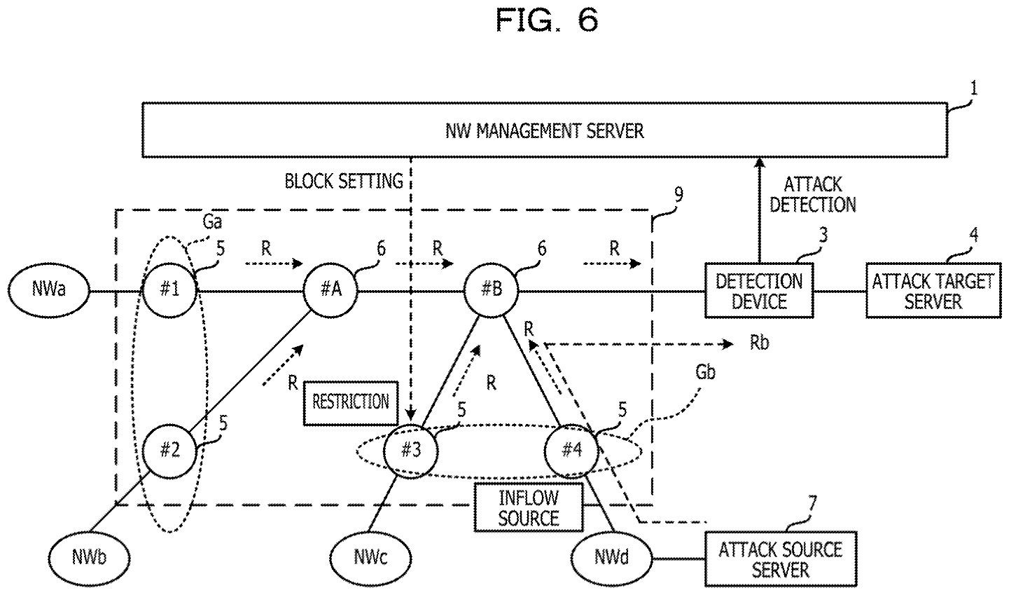

FIG. 6 is a diagram illustrating an example of an operation in which the NW management server 1 identifies an inflow source router from the edge router (#3) 5 and the edge router (#4) 5 of the remaining group Gn. In FIG. 6, components common to FIG. 1 are denoted by the same reference signs, and description thereof will be omitted.

The NW management server 1 performs block setting of traffic on the edge router (#3) 5 in order to restrict transfer of traffic addressed to the attack target server 4 from the edge router (#3) 5. At this time, the edge router (#3) 5 blocks traffic by setting the ACL according to an instruction from the NW management server 1. Thus, the transfer of traffic of the edge router (#3) 5 is restricted.

However, since the inflow source router is the edge router (#4) 5, the attack traffic is not affected by the block setting, and is continuously transferred to the attack target server 4. Thus, the detection device 3 continues to detect the attack traffic. If the edge router (#3) 5 is the inflow source router, the detection device 3 does not detect the attack traffic because the attack traffic is discarded by the edge router (#3) 5 due to the block setting.

Since no change in the attack traffic is detected, the NW management server 1 may identify the remaining edge router (#4) 5 of the group Gb as the inflow source router.

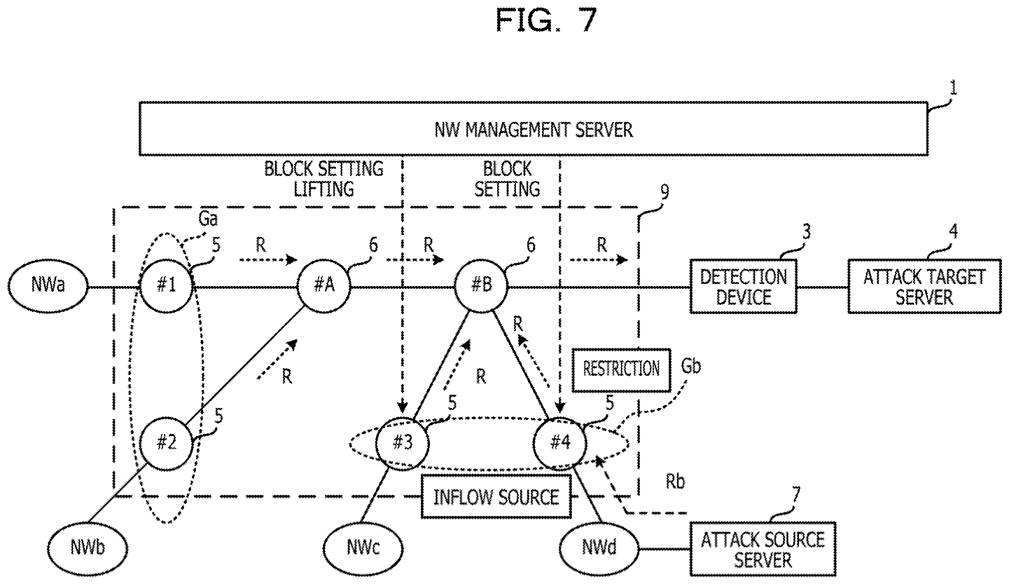

FIG. 7 is a diagram illustrating an example of an operation when the NW management server 1 has identified the inflow source router. In FIG. 7, components common to FIG. 1 are denoted by the same reference signs, and description thereof will be omitted.

The NW management server 1 lifts the block setting on the edge router (#3) 5 because reception of the attack traffic detection notification from the detection device 3 continues after the block setting is performed. Thus, the transfer of traffic from the edge router (#3) 5 to the attack target server 4 is resumed.

The NW management server 1 has identified the edge router (#4) 5 as the inflow source router, and thus performs block setting of traffic on the edge router (#4) 5 so as to restrict the transfer of traffic addressed to the attack target server 4 from the edge router (#4) 5. At this time, the edge router (#4) 5 blocks traffic by setting the ACL according to an instruction from the NW management server 1. Thus, transfer of traffic by the edge router (#4) 5 is restricted.

Furthermore, in the operation of FIG. 6, if the NW management server 1 performs block setting on the other edge router (#4) 5 instead of the edge router (#3) 5, the attack traffic is blocked at the edge router (#4) 5 and the detection notification stops, and thus the edge router (#4) 5 is identified as the inflow source router.

In this example, although the case where the edge router (#4) 5 is the inflow source router has been described, if the edge router (#1) 5 is the inflow source router, the detection notification of the attack traffic stops after performing block setting on the intermediate router (#A) 6 as illustrated in FIG. 4, and thus the NW management server 1 determines that the edge router (#1) 5 or the edge router (#2) 5 is the inflow source router.

Therefore, the NW management server 1 lifts the block setting on the intermediate router (#A) 6, and identifies the inflow source router from the edge router (#1) 5 and the edge router (#2) 5. For example, if block setting is performed on one edge router (#2) 5, the detection notification of the attack traffic continues, and thus the NW management server 1 identifies the other edge router (#1) 5 as the inflow source router.

In this manner, when a change in the attack traffic is detected, the NW management server 1 identifies the inflow source edge router from a part of the edge routers 5, and when no change in the attack traffic is detected, the NW management server 1 identifies the inflow source edge router from rest of the edge routers 5. Therefore, it is possible for the NW management server 1 to narrow down candidates for the inflow source router from all the edge routers 5.

Next, a configuration and functions of the NW management server 1 will be described.

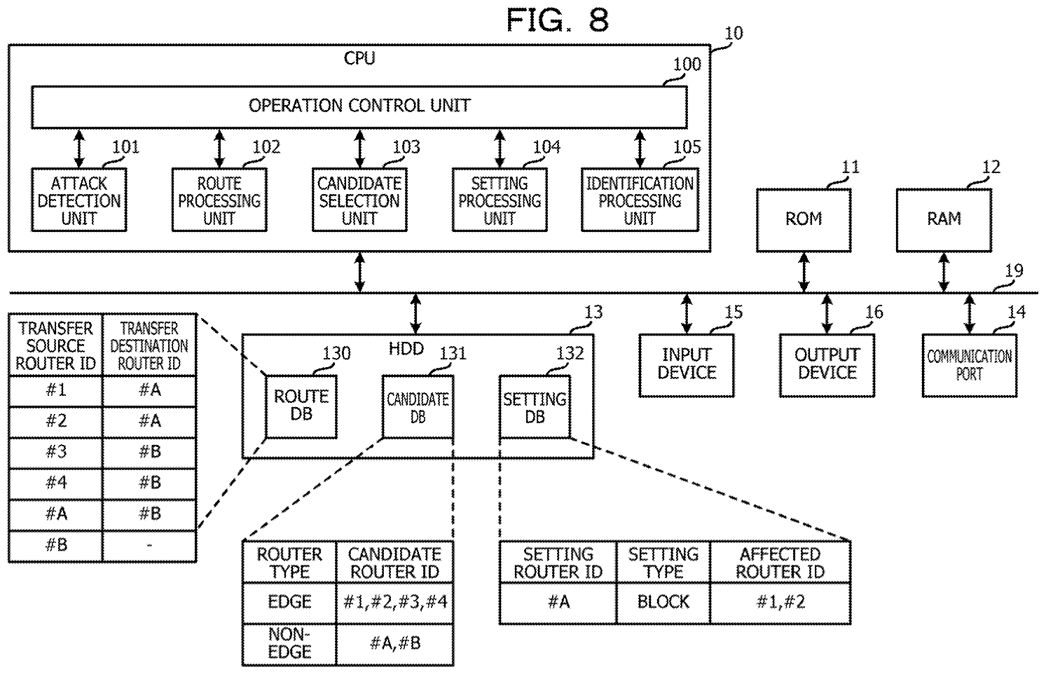

FIG. 8 is a configuration diagram illustrating an example of the NW management server 1. The NW management server 1 has a central processing unit (CPU) 10, a read only memory (ROM) 11, a random access memory (RAM) 12, a hard disk drive (HDD) 13, a communication port 14, an input device 15, and an output device 16. The CPU 10 is connected to the ROM 11, the RAM 12, the HDD 13, the communication port 14, the input device 15, and the output device 16 via a bus 19 so that signals may be input to and output from each other. Note that the CPU 10 is an example of a computer, and another processor may be provided instead of the CPU 10.

The ROM 11 stores a program for driving the CPU 10. The program includes a network management program for executing a network management method for identifying an inflow source router, and an operating system (OS).

The RAM 12 functions as a working memory of the CPU 10. The communication port 14 is, for example, a wireless local area network (LAN) card or a network interface card (NIC), and processes communication between the CPU 10 and the edge routers 5, the intermediate routers 6, and the detection device 3.

The input device 15 is a device for inputting information. Examples of the input device 15 include a keyboard, a mouse, and a touch panel, and the like. The input device 15 outputs input information to the CPU 10 via the bus 19.

The output device 16 is a device that outputs information. Examples of the output device 16 include a display and a touch panel, and the like. The output device 16 obtains information from the CPU 10 via the bus 19, and outputs the information.

When the program is read from the ROM 11, the CPU 10 forms an operation control unit 100, an attack detection unit 101, a route processing unit 102, a candidate selection unit 103, a setting processing unit 104, and an identification processing unit 105 as functions. Furthermore, the HDD 13 stores a route database (route DB)130, a candidate database (candidate DB) 131, and a setting database (setting DB) 132.

Note that the operation control unit 100, the attack detection unit 101, the route processing unit 102, the candidate selection unit 103, the setting processing unit 104, and the identification processing unit 105 may be, for example, a circuit formed by hardware such as a field programmable gate array (FPGA) or an application specified integrated circuit (ASIC). Furthermore, a storage unit for the route DB 130, the candidate DB 131, and the setting DB 132 is not limited to the HDD 13, and a memory such as an erasable programmable ROM (EEPROM) may be used.

The operation control unit 100 controls an overall operation of the NW management server 1. The operation control unit 100 instructs the attack detection unit 101, the route processing unit 102, the candidate selection unit 103, the setting processing unit 104, and the identification processing unit 105 to operate according to a predetermined algorithm.

The attack detection unit 101 is an example of a detection unit, and detects a change in attack traffic in response to restriction on transfer of attack traffic. For example, the attack detection unit 101 receives a detection notification of attack traffic and attack information such as a transmission source address and band of the attack traffic from the detection device 3 via the communication port 14. The attack detection unit 101 notifies the operation control of a detection result of attack traffic. Note that the attack detection unit 101 may include the same function as the detection device 3 so as to directly detect attack traffic from traffic transmitted from the network 9 to the attack target server 4.

The route processing unit 102 is an example of a calculation unit, and calculates each of communication routes R of traffic that respective edge routers 5 transfer to the attack target server 4. Thus, the route processing unit 102 obtains route information from each edge router 5 and each intermediate router 6 via the communication port 14. Note that the route processing unit 102 is not limited to this, and may obtain route information input from the input device 15, for example.

The operation control unit 100 instructs the route processing unit 102 to calculate a communication route R in response to, for example, a detection notification of attack traffic. The route processing unit 102 obtains route information according to an instruction from the operation control unit 100, calculates a communication route R of traffic addressed to the attack target server 4 from the route information, and registers the communication route R in the route DB 130.

In the route DB 130, transfer source router IDs and transfer destination router IDs are registered. A transfer source router ID is the router ID of an edge router 5 or an intermediate router 6 as a transfer source of traffic, and a transfer destination router ID is the router ID of an intermediate router 6 as a transfer destination of traffic.

The route processing unit 102 converts an IP address in the route information into a transfer source router ID and a transfer destination router ID. Note that when a transfer destination is the detection device 3, “-” is registered as the transfer destination router ID.

The route processing unit 102 calculates a communication route R of traffic addressed to the attack target server 4 by combining respective pieces of route information in the route DB 130. For example, the route processing unit 102 sequentially traces a transfer destination of traffic from each edge router 5 to the attack target server 4 based on the route information of each edge router 5 and each intermediate router 6 in the network 9.

For example, the edge router (#1) 5 transfers traffic addressed to the attack target server 4 to the intermediate router (#A) 6, and the intermediate router (#A) 6 transfers the traffic to the intermediate router (#B) 6. The intermediate router (#B) 6 transfers the traffic to the detection device 3.

Thus, based on the route DB 130, the route processing unit 102 calculates a communication route R passing through the intermediate router (#A) 6 and the intermediate router (#B) 6 for traffic transferred from the edge router (#1) 5 to the attack target server 4. The route processing unit 102 deletes route information that does not constitute the communication route R of the traffic addressed to the attack target server 4 from the route DB 130.

The route processing unit 102 notifies the operation control unit 100 that calculation of the communication route R has been completed. In response to the notification of completion of the calculation, the operation control unit 100 instructs the candidate selection unit 103 to select the edge router 5 or the intermediate router 6 as a restriction setting target.

The candidate selection unit 103 is an example of a selection unit, and selects, from the plurality of intermediate routers 6, a setting router where communication routes R of a plurality of flows of traffic that a part of the edge routers 5 transfer to the attack target server 4 merge. In the case of the example described above, the candidate selection unit 103 selects the intermediate router (#A) 6 where the communication routes R of traffic transferred respectively by the edge router (#1) 5 and the edge router (#2) 5 merge. Here, the intermediate router 6 is an example of a first router. Furthermore, the candidate selection unit 103 repeats the selection of the setting target router until the inflow source router is identified.

The candidate selection unit 103 manages the candidate DB 131 in which candidates for the edge router 5 and the intermediate router 6 as targets of restriction setting (hereinafter, described as “setting target routers”) are registered. In the candidate DB 131, candidate router IDs which are router IDs of edge routers 5 and intermediate routers 6 are registered by every router type. As an example, a router type “edge” indicates an edge router 5, and a router type “non-edge” indicates an intermediate router 6.

According to an instruction from the operation control unit 100, the candidate selection unit 103 registers the router IDs of an edge router 5 an intermediate router 6 which the communication route R of the traffic addressed to the attack target server 4 pass through as the candidate router IDs in the candidate DB 131 based on the route DB 130. In the case of the above example, the candidate selection unit 103 registers the router IDs of the edge router (#1) 5 to the edge router (#4) 5, the intermediate router (#A) 6, and the intermediate router (#B) 6.

The candidate selection unit 103 selects a setting target router from the candidate DB 131. The candidate DB 131 is updated every time candidates for the inflow source router are narrowed down. The candidate selection unit 103 registers the router ID of the setting target router in the setting DB 132.

In the setting DB 132, a setting router ID, a setting type, and an affected router ID are registered. The setting router ID is the router ID of a setting target router, and the setting type indicates the type of restriction setting (block setting or upper limit band setting). In the case of the example illustrated in FIG. 4, the candidate selection unit 103 registers the router ID “#A” in the setting router ID and registers “block” in the setting type. Although the setting type “block” in this example indicates block setting, the restriction setting is not limited to the block setting, and includes, for example, upper limit band setting for causing the band of traffic to be equal to or less than a predetermined upper limit band.

Furthermore, the candidate selection unit 103 selects the router IDs of an edge router 5 and an intermediate router 6 upstream of the setting target router on the communication route R of the traffic addressed to the attack target server 4 based on the route DB 130, and registers them as affected router IDs in the setting DB 132. The affected router ID is the router ID of the edge router 5 that transfers traffic affected by restriction setting of the setting target router, and is the router ID of the setting target router when the setting target router is the edge router 5.

In the case of the example illustrated in FIG. 4, the candidate selection unit 103 registers as the affected router ID the router IDs “#1” and “#2” of the edge router (#1) 5 and the edge router (#2) 5 upstream of the intermediate router (#A) 6. The candidate selection unit 103 notifies the operation control unit 100 of completion of selection of the setting target router. Upon receiving a selection completion notification from the candidate selection unit 103, the operation control unit 100 instructs the setting processing unit 104 to perform the setting process.

The setting processing unit 104 is an example of an instruction unit, and instructs the setting target router to restrict transfer of attack traffic. For example, upon receiving a setting processing instruction from the operation control unit 100, the setting processing unit 104 performs restriction setting on the edge router 5 or the intermediate router 6 corresponding to the router ID based on the setting DB 132.

The setting processing unit 104 transmits setting information regarding a transmission source address and a setting type of attack traffic and the like included in attack information to the setting target router via the communication port 14. The setting target router restricts traffic based on the setting information. For example, when the setting type is “block”, the setting target router restricts attack traffic by registering the transmission source address in the ACL, and when the setting type is “upper limit band setting”, the setting target router controls the attack traffic by setting a policer or shaper by the transmission source address.

The setting processing unit 104 notifies the operation control unit 100 of completion of the restriction setting. Upon receiving the setting completion notification from the setting processing unit 104, the operation control unit 100 instructs the identification processing unit 105 to perform a setting process.

The identification processing unit 105 identifies an inflow source router based on a change in attack traffic in response to the restriction setting according to an instruction from the operation control unit 100. The change in the traffic is detected by the attack detection unit 101, and the operation control unit 100 notifies the identification processing unit 105 of this change.

When a change in attack traffic is detected, the identification processing unit 105 identifies the inflow source router from a part of the edge routers 5. Furthermore, when no change in attack traffic is detected, the identification processing unit 105 identifies the inflow source router from rest of the edge routers 5. Thus, the identification processing unit 105 narrows down candidates for the inflow source router from all the edge routers 5.

In the operation illustrated in FIG. 4, the attack detection unit 101 detects no change in attack traffic in response to the restriction setting of the intermediate router (#A) 6. Thus, the identification processing unit 105 excludes the edge router (#1) 5 and the edge router (#2) 5 corresponding to the affected router IDs in the setting DB 132 from candidates for the inflow source router.

At this time, the identification processing unit 105 deletes the router IDs of the edge router (#1) 5 and the edge router (#2) 5 from the route DB 130 and the candidate DB 131. Moreover, the identification processing unit 105 also deletes the router ID of the intermediate router (#A) 6 for which no edge router 5 is registered upstream in the route DB 130 from the route DB 130 and the candidate DB 131.

Furthermore, unlike the example in FIG. 4, if the edge router (#1) 5 is the inflow source router, the attack detection unit 101 detects no change in attack traffic in response to the restriction setting of the intermediate router (#A) 6. In this case, the identification processing unit 105 excludes other edge routers (#3) 5 and (#4) 5 from the candidates for the inflow source router. At this time, the identification processing unit 105 deletes the router IDs of the edge router (#3) 5 and the edge router (#4) 5 from the route DB 130 and the candidate DB 131.

In this manner, the identification processing unit 105 narrows down candidates for the inflow source router by updating the route DB 130 and the candidate DB 131 every time the restriction setting is performed. When candidates for the inflow source router finally becomes only one edge router 5 by repeatedly narrowing down the candidates for the inflow source router, the identification processing unit 105 identifies the edge router 5 as the inflow source router.

The identification processing unit 105 notifies the operation control unit 100 of whether or not identification of the inflow source router has been completed. When the inflow source router is not identified, the operation control unit 100 instructs the candidate selection unit 103 to select a setting target router. According to the instruction of selection, the candidate selection unit 103 selects again a setting target router from the updated candidate DB 131, and the setting processing unit 104 gives an instruction on restriction setting on the setting target router.

Furthermore, when identification of the inflow source router is completed, the operation control unit 100 instructs the setting processing unit 104 to execute restriction setting. The setting processing unit 104 performs restriction setting on one edge router 5 remaining in the candidate DB 131, for example, the inflow source router. At this time, the operation control unit 100 may output the router ID of the inflow source router to the output device so that an administrator of the network 9 is able to know the inflow source router.

As described above, the identification processing unit 105 identifies the inflow source router by updating the route DB 130 and the candidate DB 131 based on whether or not there is a change in attack traffic in response to restriction setting.

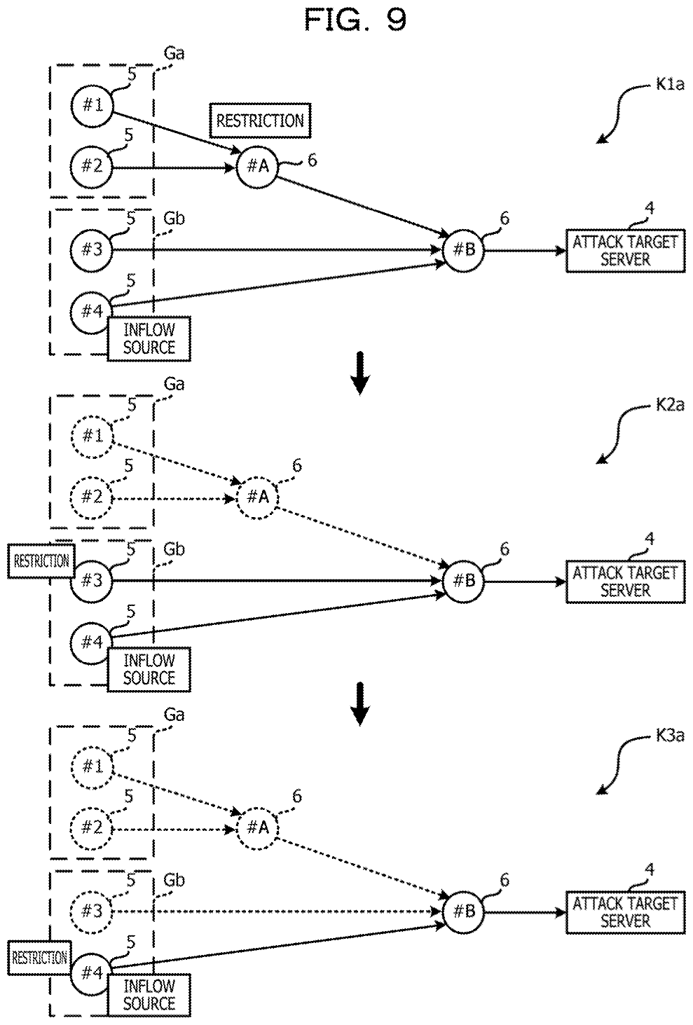

FIG. 9 is a diagram illustrating an example of a tree structure of communication routes R described in the route DB 130 in a process of identifying the inflow source router. Reference sign K1a corresponds to the state illustrated in FIG. 4, reference sign K2a corresponds to the state illustrated in FIG. 6, and reference sign K3a corresponds to the state illustrated in FIG. 7.

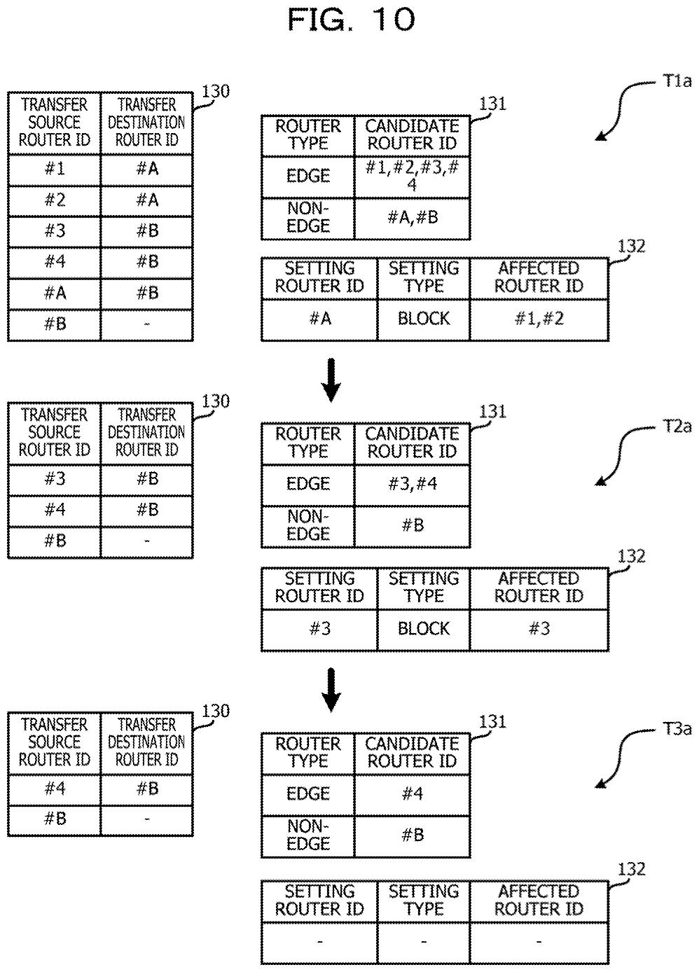

Furthermore, FIG. 10 is a diagram illustrating an example of the route DB 130, the candidate DB 131, and the setting DB 132 in a process of identifying the inflow source router. Reference sign T1a corresponds to the state illustrated in FIG. 4, reference sign T2a corresponds to the state illustrated in FIG. 6, and reference sign T3a corresponds to the state illustrated in FIG. 7. Hereinafter, a process of identifying the inflow source router will be described with reference to FIGS. 9 and 10.

As indicated by reference sign T1a, communication routes R from all the edge routers 5 to the attack target server 4 are registered in the route DB 130, and all of the edge routers 5 and the intermediate routers 6 are registered in the candidate DB 131. The candidate selection unit 103 selects, as the setting target router, the intermediate router (#A) 6 that is a merge destination of the communication routes R from the edge router (#1) 5 and the edge router (#2) 5 based on the route DB 130 from the respective edge routers 5 in the candidate DB 131.

Furthermore, the candidate selection unit 103 also registers the router ID of the intermediate router (#A) 6 and the router IDs of the edge router (#1) 5 and the edge router (#2) 5 upstream of the intermediate router (#A) 6 as a setting router ID and affected router IDs, respectively, in the setting DB 132. Moreover, the candidate selection unit 103 registers block setting as a setting type.

The setting processing unit 104 instructs the intermediate router (#A) 6 to restrict traffic by block setting based on the setting DB 132, as indicated by reference sign K1a. Accordingly, the edge routers 5 are divided into a group Ga of the edge router (#1) 5 and the edge router (#2) 5 affected by the traffic restriction, and a group Gb of the edge router (#3) 5 and the edge router (#4) 5 not affected by the traffic restriction.

Since the inflow source router is the edge router (#4) 5, the attack traffic is not affected by the restriction. Therefore, the attack detection unit 101 does not detect a change in the attack traffic. Thus, the identification processing unit 105 excludes the edge routers 5 of the group Ga from candidates for the inflow source router, and identifies the inflow source router from rest of the edge routers 5 of the group Gb.

Next, as indicated by reference sign T2a, the identification processing unit 105 deletes the router IDs “#1” and “#2” of the edge routers 5 of the group Ga from the route DB 130. Moreover, the identification processing unit 105 also deletes the router ID “#A” of the intermediate router (#A) 6 from which all the router IDs “#1” and “#2” of the edge routers 5 upstream on the communication routes R have been deleted, from the route DB 130. Consequently, as indicated by reference sign K2a, only the communication routes R from the edge router (#3) 5 and the edge router (#4) 5 of the group Gb to the attack target server 4 are registered in the route DB 130.

Furthermore, as indicated by reference sign T2a, the identification processing unit 105 deletes the router IDs “#1” and “#2” of the edge routers 5 of the group Ga and the router ID “#A” of the intermediate router (#A) 6 from the candidate DB 131. Accordingly, the identification processing unit 105 narrows down candidates for the inflow source router to the edge router (#3) 5 and the edge router (#4) 5 of the remaining group Gb.

The candidate selection unit 103 selects the edge router (#3) 5 in the candidate DB 131 as a setting target router based on the route DB 130. The candidate selection unit 103 registers the router ID of the edge router (#3) 5 as a setting router ID and an affected router ID in the setting DB 132. Moreover, the candidate selection unit 103 registers block setting as the setting type.

The setting processing unit 104 instructs the edge router (#3) 5 to restrict traffic by the block setting based on the setting DB 132, as indicated by reference sign K2a.

Since the inflow source router is the edge router (#4) 5, the attack traffic is not affected by the restriction. Therefore, the attack detection unit 101 does not detect a change in the attack traffic.

Next, as indicated by reference sign T3a, the identification processing unit 105 deletes the router ID “#3” of the edge router (#3) 5 from the route DB 130 and the candidate DB 131. Consequently, as indicated by reference sign K3a, only the communication route R from the edge router (#4) 5 to the attack target server 4 is registered in the route DB 130.

Furthermore, in the candidate DB 131, only the edge router (#4) 5 is registered as a router of the router type “edge”. Thus, the identification processing unit 105 identifies the edge router (#4) 5 as the inflow source router, and ends the identification process.

Next, a flow of processing by the NW management server 1 will be described.

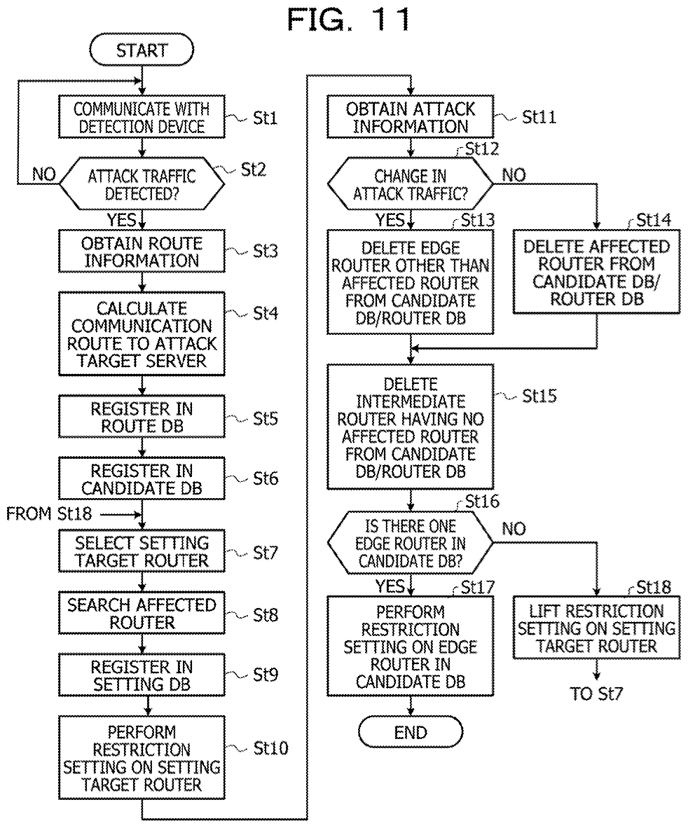

FIG. 11 is a flowchart illustrating an example of processing by the NW management server 1. This processing is an example of a network management program and a network management method.

The attack detection unit 101 communicates with the detection device 3 to confirm presence or absence of attack traffic (step St1). Note that the detection device 3 may transmit a detection notification of the attack traffic to the NW management server 1 in response to a request from the attack detection unit 101, or may voluntarily transmit the detection notification.

The operation control unit 100 determines whether or not attack traffic has been detected based on the detection notification (step St2). When attack traffic is not detected (No in step St2), the respective process of step St1 is executed again, or if attack traffic is detected (Yes in step St2), respective processes in and after step St3 are executed.

When attack traffic is detected (Yes in step St2), the route processing unit 102 obtains route information from each of the edge routers 5 and the intermediate routers 6 in the network 9 (step St3). Next, the route processing unit 102 calculates a communication route R of traffic addressed to the attack target server 4 transferred from each edge router 5 from the route information (step St4), and registers the communication route R in the route DB 130 (step St5).

Next, the candidate selection unit 103 registers the router ID of each edge router 5 and each intermediate router 6 on the communication route R in the candidate DB 131 as candidate router IDs based on the route DB 130 (step St6). The router ID of an edge router 5 corresponds to the router type “edge”, and the router ID of an intermediate router 6 corresponds to the router type “non-edge”.

Next, the candidate selection unit 103 selects the router ID of a setting target router from the candidate router IDs in the candidate DB 131 (step St7). The candidate selection unit 103 selects the router ID of a new setting target router every time the inflow source router is narrowed down. The candidate selection unit 103 selects, at least initially, the router ID of the intermediate router 6 where the communication routes R of a plurality of flows of traffic transferred by a part of the edge routers 5 merge. Thus, the identification processing unit 105 may determine whether or not the part of the edge routers 5 includes the inflow source router.

Next, the candidate selection unit 103 searches for an affected router of the setting target router based on the route DB 130 (step St). When the setting target router is an intermediate router 6, the candidate selection unit 103 searches for an edge router 5 upstream on the communication route R as an affected router, and when the setting target router is an edge router 5, the edge router 5 is searched for as the affected router.

Next, the candidate selection unit 103 registers the router ID of the setting target router and the router ID of the affected router as a setting router ID and an affected router ID, respectively, in the setting DB 132 (step St9). Furthermore, the candidate selection unit 103 registers “block” or “upper limit band setting” as the setting type of the setting DB 132.

Next, the setting processing unit 104 performs restriction setting on the setting target router according to the setting DB 132 (step St10). The setting target router restricts attack traffic by setting of ACL, a policer, or a shaper according to an instruction by the setting processing unit 104.

Next, the attack detection unit 101 obtains attack information from the detection device 3 in order to determine a change in the attack traffic (step St11). Next, the attack detection unit 101 determines presence or absence of a change in the attack traffic in response to the restriction setting based on the attack information (step St12).

When a change in the attack traffic is detected (Yes in step St12), the identification processing unit 105 deletes the router ID of an edge router 5 other than the affected router registered in the setting DB 132 from the candidate DB 131 and the route DB 130 (step St13). Accordingly, the edge router 5 other than the affected router is excluded from candidates for the inflow source router.

Furthermore, if no change in the attack traffic is detected (No in step St12), the identification processing unit 105 deletes the router ID of the affected router registered in the setting DB 132 from the candidate DB 131 and the route DB 130 (step St14). Consequently, the affected router is excluded from the candidates for the inflow source router.

Next, the identification processing unit 105 searches the route DB 130 for an intermediate router 6 having no affected router due to the above deletion, and deletes the router ID thereof from the candidate DB 131 and the route DB 130 (step St15). Note that if there is no intermediate router 6 corresponding to the above, the deletion is not executed.

Next, the identification processing unit 105 determines whether or not there is only one edge router 5 registered in the candidate DB 131 (step St16). When there is only one edge router 5 registered in the candidate DB 131 (Yes in step St16), the identification processing unit 105 identifies that the edge router 5 as the inflow source router, and the setting processing unit 104 performs restriction setting on the inflow source router (step St17). Consequently, inflow of the attack traffic from the inflow source router to the network 9 is suppressed.

Furthermore, when there is a plurality of edge routers 5 registered in the candidate DB 131 (No in step St16), the setting processing unit 104 lifts the restriction setting of the setting target router (step St18). Thus, the candidate selection unit 103 may select a new setting target router from the edge routers 5 registered in the candidate DB 131. Thereafter, the respective processes in and after step St7 are executed again. Thus, the NW management server 1 executes the processing.

As described above, the route processing unit 102 calculates the communication route R of traffic that each of the edge routers 5 transfers to the attack target server 4. The candidate selection unit 103 selects an intermediate router 6 where communication routes R of a plurality of flows of traffic that a part of the edge routers 5 transfer to the attack target server 4 merge, and the setting processing unit 104 instructs the intermediate router 6 to restrict transfer of attack traffic.

The attack detection unit 101 detects a change in the attack traffic in response to the transfer restriction of the attack traffic. The identification processing unit 105 identifies the inflow source router from the part of the edge routers 5 when a change in the attack traffic is detected, or identifies the inflow source router from rest of the edge routers 5 when no change in the attack traffic is detected.

With the above configuration, when an intermediate router 6 restricts transfer of traffic addressed to the attack target server 4 according to an instruction by the setting processing unit 104, transfer of a plurality of flows of traffic flowing in from respective edge routers 5 (affected routers) upstream of the intermediate router 6 is restricted collectively. Since the attack detection unit 101 detects a change in attack traffic in response to transfer restriction, the identification processing unit 105 may narrow down candidates for the inflow source router to either of respective edge routers 5 upstream of the intermediate router 6 and other edge routers 5 according to presence or absence of a change in attack traffic.

Therefore, it is possible for the NW management server 1 to quickly identify the inflow source router with a smaller number of times of restriction setting than in the second comparative example.

### Second Embodiment

When there is a plurality of intermediate routers 6 where communication routes R of a plurality of flows of traffic from a part of edge routers 5 merge, the candidate selection unit 103 may select a setting target router whose number of affected routers is closest to half of the edge routers 5 so that the inflow source router is identified more quickly.

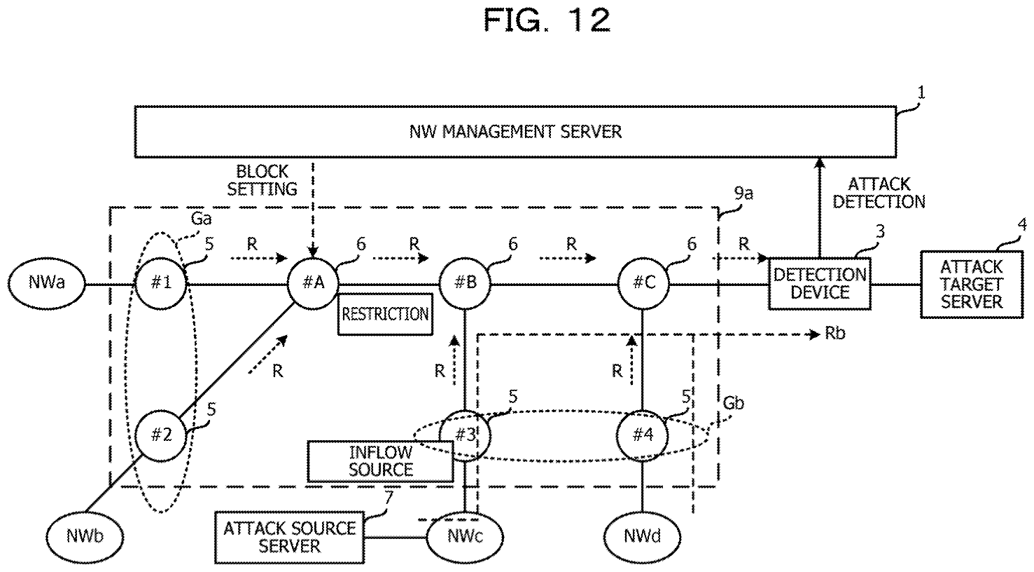

FIG. 12 is a diagram illustrating an example of restriction setting in a second embodiment. In FIG. 12, components common to FIG. 4 are denoted by the same reference signs, and description thereof will be omitted.

The NW management server 1 manages a network 9a instead of the network 9. The network 9a includes an edge router (#1) 5 to an edge router (#4) 5 and an intermediate router (#A) 6 to an intermediate router (#C) 6. The intermediate router (#A) 6 is adjacent to the intermediate router (#B) 6, the edge router (#1) 5, and the edge router (#2) 5, and the intermediate router (#B) 6 is adjacent to the intermediate router (#A) 6, the intermediate router (#C) 6, and the edge router (#3) 5.

The intermediate router (#C) 6 is adjacent to the intermediate router (#B) 6, the edge router (#4) 5, and the detection device 3. Furthermore, the attack source server 7 is connected to an external network NWc to which the edge router (#3) 5 is connected. Thus, the edge router (#3) 5 is an inflow source router of attack traffic.

As described above, the network 9a includes the intermediate router (#A) 6 and the intermediate router (#B) 6 where communication routes R of a plurality of flows of traffic addressed to the attack target server 4 transferred by a part of the edge routers 5 merge.

As a setting target router, the candidate selection unit 103 selects, out of the intermediate router (#A) 6 and the intermediate router (#B) 6, the intermediate router (#A) 6 whose number of edge routers 5 upstream on the communication route R of the traffic addressed to the attack target server 4, for example, affected routers, is close to half of all the edge routers 5. Here, the number of affected routers of the intermediate router (#A) 6 is two, the edge router (#1) 5 and the edge router (#2) 5. The number of affected routers of the intermediate router (#B) 6 is 3, the edge router (#1) 5 to the edge router (#3) 5. The number of affected routers of the intermediate router (#C) 6 is 4, the edge router (#1) 5 to the edge router (#4) 5.

Thus, the candidate selection unit 103 selects the intermediate router (#A) 6 whose number of affected routers is two, which is half of the total number (four) of the edge routers 5. Accordingly, it is possible for the NW management server 1 to divide all the edge routers 5 into a group Ga including the edge router (#1) 5 and the edge router (#2) 5 and a group Gb including the edge router (#3) 5 and the edge router (#4) 5, similarly to the first embodiment.

Thus, when the setting processing unit 104 has performed block setting on the intermediate router (#A) 6, the identification processing unit 105 may narrow down candidates for the inflow source router to two edge routers 5 of the group Ga or the group Gb regardless of a detection result of a change in the attack traffic.

On the other hand, when the candidate selection unit 103 has selected the intermediate router (#B) 6 as the setting target router and the setting processing unit 104 has performed block setting on the intermediate router (#B) 6, a change in the attack traffic is detected because the inflow source router is an affected router of the intermediate router (#B) 6. Thus, the identification processing unit 105 narrows down the candidates for the inflow source router to the three edge routers (#1) 5 to (#3) 5 upstream of the intermediate router (#B) 6, but it takes time to identify the inflow source router because the number of candidate edge routers 5 is larger than in the case where block setting has been performed on the intermediate router (#A) 6.

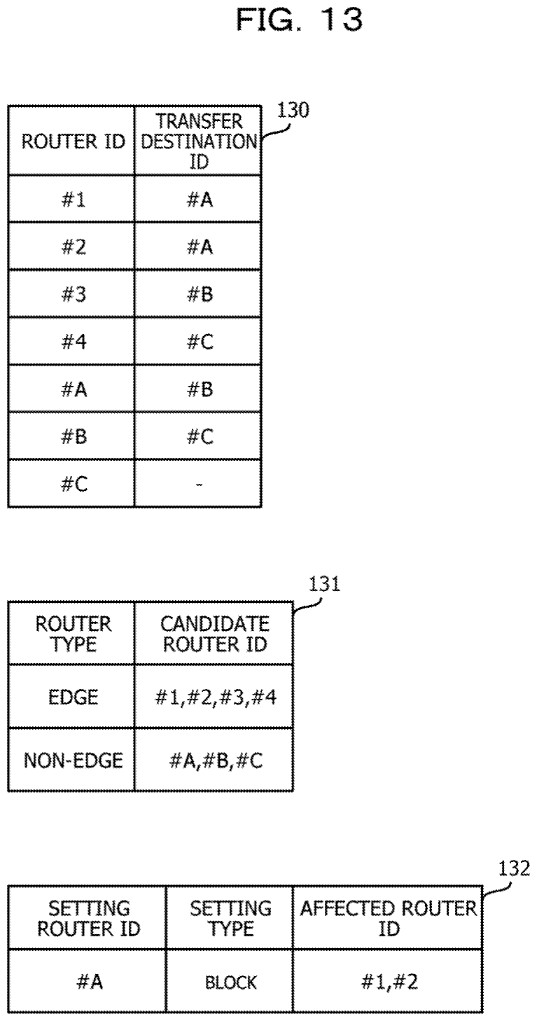

FIG. 13 is a diagram illustrating a route DB 130, a candidate DB 131, and a setting DB 132 in the second embodiment. The route processing unit 102 calculates communication routes R based on route information and registers the communication routes R in the route DB 130. The candidate selection unit 103 registers the router IDs of an edge router 5 and an intermediate router 6 on the communication routes R in the candidate DB 131 based on the route DB 130.

Furthermore, the candidate selection unit 103 registers the router ID “#A” of the intermediate router (#A) 6 selected as a setting target router and the router IDs “#1” and “#2” of the affected routers as a setting router ID and an affected router ID in the setting DB 132. Furthermore, the candidate selection unit 103 registers “block” as a setting type.

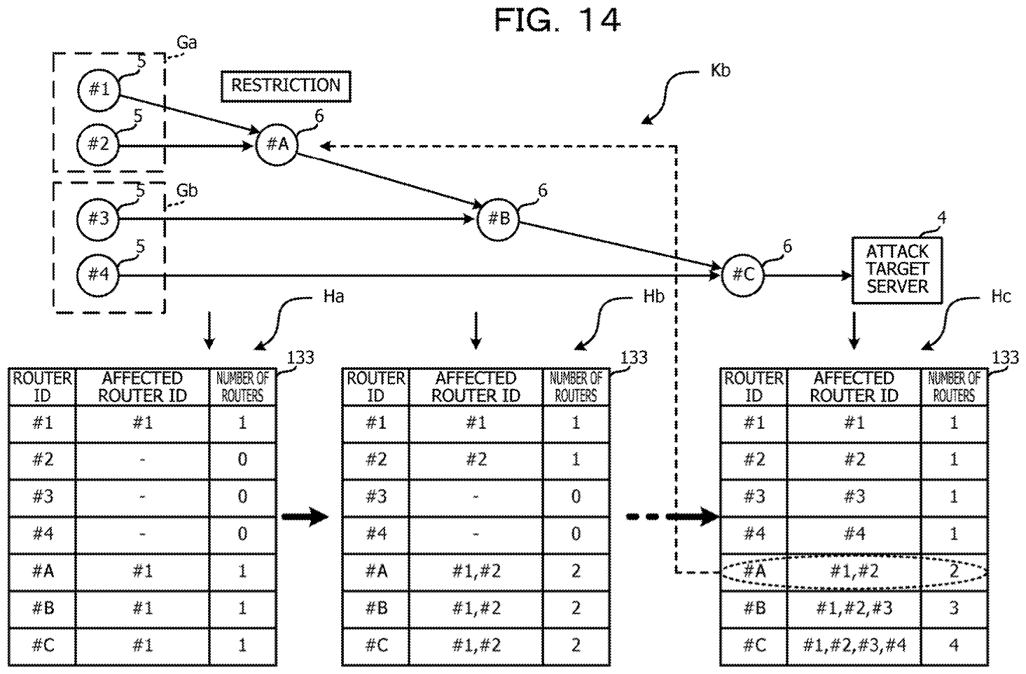

FIG. 14 is a diagram illustrating an example of a process of selecting a setting target router. Reference sign Kb indicates a tree structure of the communication routes R described in the route DB 130.

The candidate selection unit 103 calculates the number of affected routers of each edge router 5 and each intermediate router 6 from the tree structure indicated by reference sign Kb, and stores the number in a number information table 133. The candidate selection unit 103 generates the number information table 133 in advance and stores the number information table 133 in the HDD 13 or the RAM 12.

In the number information table 133, the router ID of an edge router 5 or an intermediate router 6, the affected router ID that is the router ID of an affected router, and the number of routers that is the number of affected routers are registered. The candidate selection unit 103 sequentially selects an edge router 5 and an intermediate router 6 one by one, and registers them as affected router IDs of an edge router 5 or an intermediate router 6 where the edge router 5 or the intermediate router 6 selected is an affected router.

Reference sign Ha indicates the number information table 133 when the candidate selection unit 103 selects the edge router (#1) 5 as an affected router. The candidate selection unit 103 registers a router ID “#1” as the affected router ID of the edge router (#1) 5 and the intermediate router (#A) 6 to the intermediate router (#C) 6 that are downstream where the edge router (#1) 5 is an affected router. Furthermore, after registering the affected router ID, the candidate selection unit 103 adds one to the number of routers. Thus, the number of routers of each of the edge router (#1) 5 and the intermediate router (#A) 6 to the intermediate router (#C) 6 is one.

Reference sign Hb indicates the number information table 133 when the candidate selection unit 103 selects the edge router (#2) 5 as an affected router. The candidate selection unit 103 registers a router ID “#2” as the affected router ID of the edge router (#2) 5 and the intermediate router (#A) 6 to the intermediate router (#C) 6 that are downstream where the edge router (#2) 5 is an affected router. Furthermore, after registering the affected router ID, the candidate selection unit 103 adds one to the number of routers. Thus, the number of routers of the edge router (#2) 5 is one, and the number of routers of each of the intermediate router (#A) 6 to the intermediate router (#C) 6 is two.

The candidate selection unit 103 sequentially selects the rest of the edge routers 5 and the intermediate routers 6 and performs processes similar to the above.

Reference sign Hc indicates the number information table 133 after all of the edge routers 5 and the intermediate routers 6 have been selected. In the number of routers, a total value of the number of affected routers of each edge router 5 and each intermediate router 6 corresponding to the router ID is registered.

The candidate selection unit 103 selects, from the number information table 133, the intermediate router (#A) 6 whose number of routers is closest to half of all the edge routers 5 as a setting target router (see the dotted circle). Therefore, the setting processing unit 104 performs block setting on the intermediate router (#A) 6.

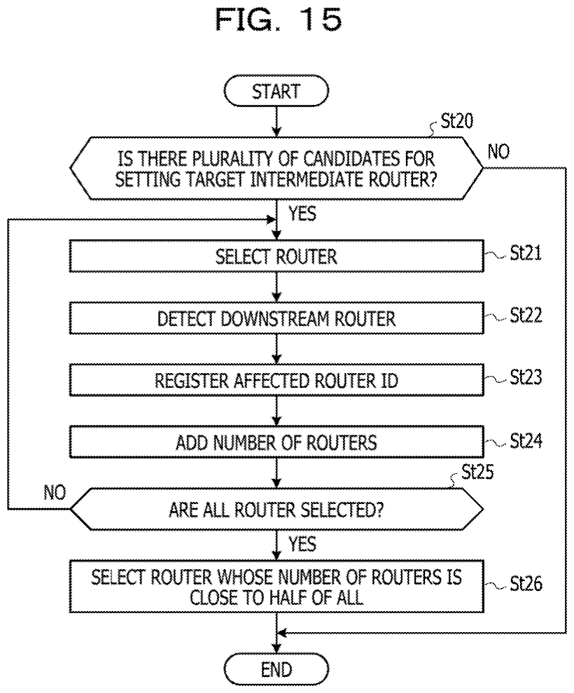

FIG. 15 is a flowchart illustrating an example of the process of selecting the setting target router. This process corresponds to the process of step St7 in FIG. 11.

The candidate selection unit 103 determines, based on the route DB 130, whether or not there is a plurality of intermediate routers 6 where communication routes R of a plurality of flows of traffic from a part of the edge routers 5 merge as candidates for the setting target router (step St20). If there is only one candidate intermediate router 6 (No in step St20), the process ends.

If there is a plurality of candidate intermediate routers 6 (Yes in step St20), the candidate selection unit 103 selects one of the edge routers 5 or the intermediate routers 6 as an affected router based on the route DB 130 (step St21). Next, the candidate selection unit 103 detects an edge router 5 and an intermediate router 6 downstream of the selected router based on the route DB 130 (step St22). Here, the edge router 5 and the intermediate router 6 downstream are routers where the selected router is an affected router.

Next, for the detected edge router 5 and intermediate router 6 downstream, the candidate selection unit 103 registers the router ID of the selected router as an affected router ID in the number information table 133 (step St23). Next, the candidate selection unit 103 adds one to the number of routers in the number information table 133 for the edge router 5 and the intermediate router 6 downstream for which the affected router ID is registered (step St24).

Next, the candidate selection unit 103 determines whether all of the edge routers 5 and the intermediate routers 6 have been selected (step St25). When there is an unselected edge router 5 or intermediate router 6 (No in step St25), the respective processes in and after step St21 are executed again.

When all of the edge routers 5 and the intermediate routers 6 have been selected (Yes in step St25), the candidate selection unit 103 sets the intermediate router 6 whose number of routers is closest to half of the edge routers 5 from the number information table 133 as a setting target router (step St26). In this manner, the process of selecting a setting target router is executed.

As described above, when there are two or more intermediate routers 6 where communication routes R of a plurality of flows of traffic addressed to the attack target server 4 merge as candidates for the setting target router, the candidate selection unit 103 selects an intermediate router whose number of affected routers is closest to half of the total number of edge routers 5 from among the intermediate routers 6.

Thus, when the restriction setting has been performed on the setting target router, it is possible for the identification processing unit 105 to narrow down the number of candidates for the inflow source router to about half. Therefore, it is possible for the NW management server 1 to more quickly identify the inflow source router. Note that in this example, the case where the number of all edge routers 5 is an even number is given, but it may be an odd number. In this case, half of the total number of edge routers is a decimal, but the candidate selection unit 103 may obtain an effect similar to above by selecting an intermediate router 6 whose number of affected routers is closest to the decimal.

### Third Embodiment

When there is a plurality of intermediate routers 6 where communication routes R of a plurality of flows of traffic from a part of edge routers 5 merge as candidates for a setting target router, the candidate selection unit 103 may select the intermediate router 6 whose longest distance to an edge router 5 is shortest as the setting target router from the intermediate routers 6 that are merge destinations of the communication routes R of traffic addressed to the attack target server 4. Consequently, transfer of attack traffic is restricted at the intermediate router 6 close to external networks NWa to NWd until the inflow source router is identified, and thus pressure on band by the attack traffic to other normal traffic is reduced.

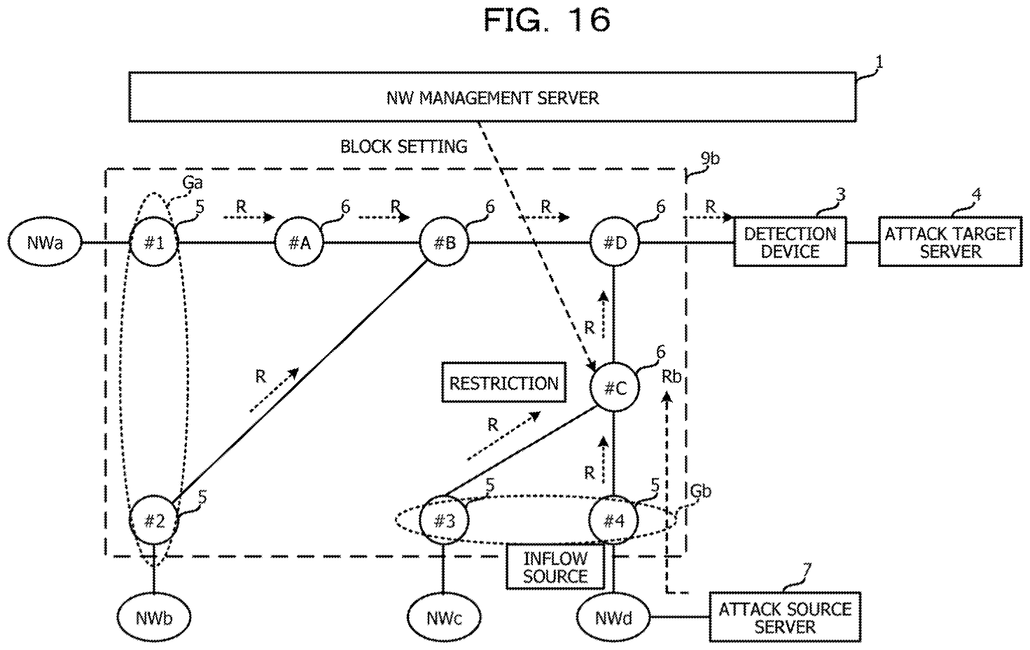

FIG. 16 is a diagram illustrating an example of restriction setting in a third embodiment. In FIG. 16, components common to FIG. 4 are denoted by the same reference signs, and description thereof will be omitted.

The NW management server 1 manages a network 9b instead of the network 9. The network 9b includes an edge router (#1) 5 to an edge router (#4) 5 and an intermediate router (#A) 6 to an intermediate router (#D) 6. The intermediate router (#A) 6 is adjacent to the intermediate router (#B) 6 and the edge router (#1) 5, and the intermediate router (#B) 6 is adjacent to the intermediate router (#A) 6, the intermediate router (#D) 6, and the edge router (#2) 5. The intermediate router (#C) 6 is adjacent to the intermediate router (#D) 6, the edge router (#3) 5, and the edge router (#4) 5, and the intermediate router (#D) 6 is adjacent to the intermediate router (#B) 6, the intermediate router (#C) 6, and the detection device 3.

As described above, the network 9b includes the intermediate router (#B) 6 and the intermediate router (#C) 6 where the communication routes R of a plurality of flows of traffic addressed to the attack target server 4 transferred by a part of the edge routers 5 merge.

The candidate selection unit 103 selects as the setting target router the intermediate router (#C) 6 whose maximum value of distances to affected routers that are edge routers 5 upstream on the communication routes R is smallest, out of the intermediate router (#B) 6 and the intermediate router (#C) 6. When the distance is represented by the number of hops, the number of hops from the intermediate router (#C) 6 to each of the edge router (#3) 5 and the edge router (#4) 5 is one hop. Thus, the maximum value of respective distances from the intermediate router (#C) 6 to the edge router (#3) 5 and the edge router (#4) 5 is one hop.

Furthermore, the number of hops from the intermediate router (#B) 6 to the edge router (#1) 5 is two hops, and the number of hops from the intermediate router (#B) 6 to the edge router (#2) 5 is one hop. Thus, the maximum value of respective distances from the intermediate router (#B) 6 to the edge router (#1) 5 and the edge router (#2) 5 is two hops.

Therefore, the candidate selection unit 103 selects the intermediate router (#C) having the smaller maximum value of distance as the setting target router. Thus, the attack traffic is transmitted only to the link between the intermediate router (#C) 6 and the edge router (#4) 5.

On the other hand, if the attack source server 7 is connected to the external network NWd and the other intermediate router (#B) 6 is selected as the setting target router, the attack traffic is transmitted to the link between the intermediate router (#B) 6 and the intermediate router (#A) 6 and the link between the intermediate router (#A) 6 and the edge router (#1) 5. Thus, the number of links where the attack traffic affects other traffic is larger than when the intermediate router (#C) 6 is set as the setting target router.

Note that, by selecting the intermediate router (#C), it is possible for the NW management server 1 to divide all the edge routers 5 to a group Ga including the edge router (#1) 5 and the edge router (#2) 5 and a group Gb including the edge router (#3) 5 and the edge router (#4) 5, similarly to the first embodiment.

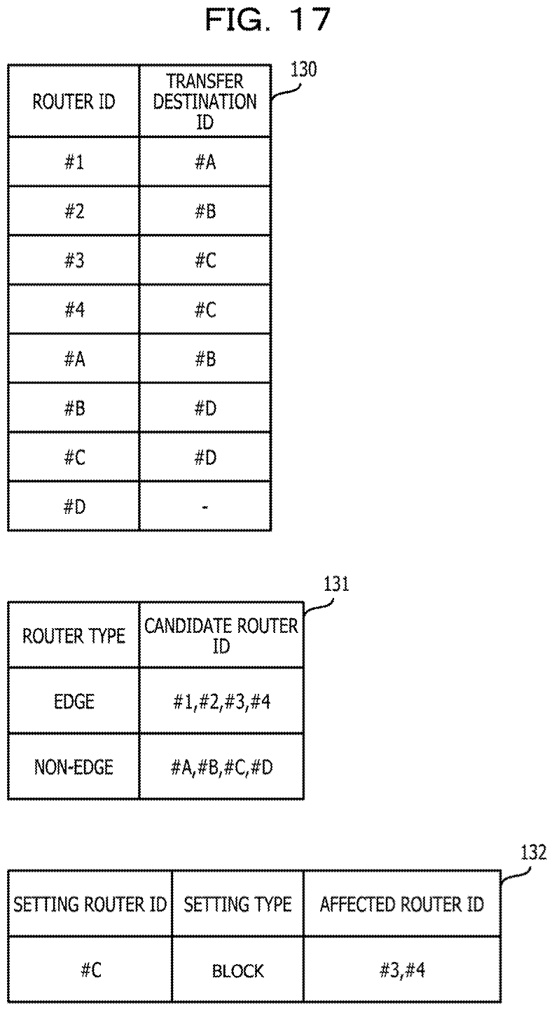

FIG. 17 is a diagram illustrating a route DB 130, a candidate DB 131, and a setting DB 132 in the third embodiment. The route processing unit 102 calculates communication routes R based on route information and registers the communication routes R in the route DB 130. The candidate selection unit 103 registers the router IDs of an edge router 5 and an intermediate router 6 on the communication routes R in the candidate DB 131 based on the route DB 130.

Furthermore, the candidate selection unit 103 also registers the router ID “#C” of the intermediate router (#C) 6 selected as the setting target router and the router IDs “#3” and “#4” of affected routers as setting router IDs and affected router IDs in the setting DB 132. Furthermore, the candidate selection unit 103 registers “block” as a setting type.

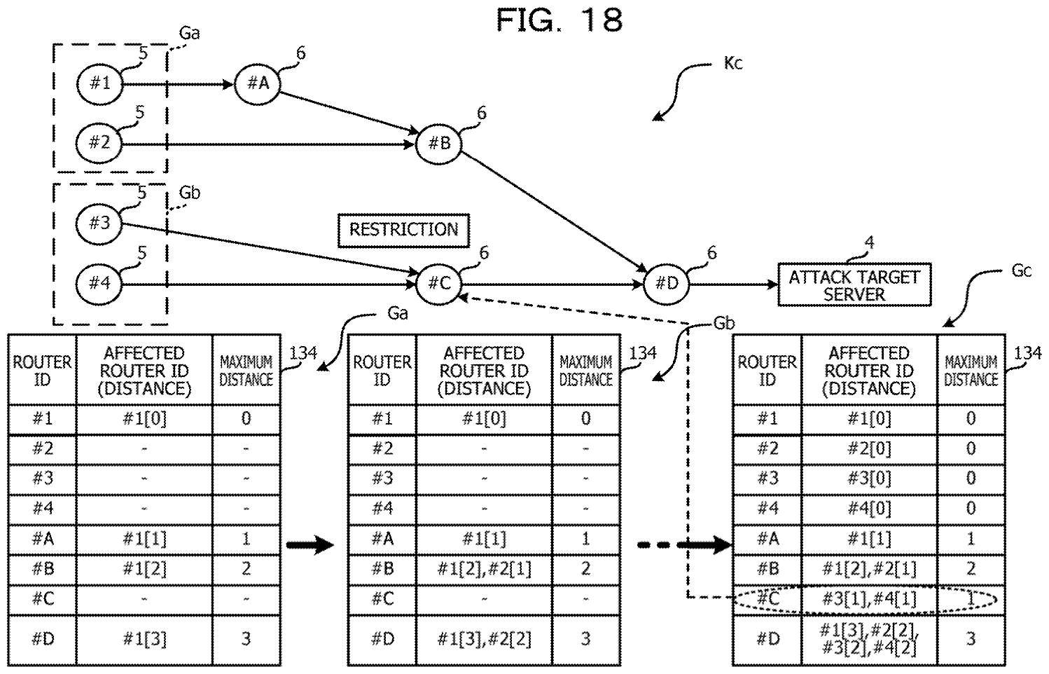

FIG. 18 is a diagram illustrating another example of the process of selecting the setting target router. Reference sign Kc indicates a tree structure of the communication route R described in the route DB 130.

The candidate selection unit 103 calculates the distance (for example, the number of hops) between each edge router 5 and each intermediate router 6 from the tree structure indicated by reference sign Kc and stores the distance in a distance information table 134. The candidate selection unit 103 generates the distance information table 134 in advance and causes the HDD 13 or the RAM 12 to retain the distance information table 134.

In the distance information table 134, the router ID of an edge router 5 or an intermediate router 6, the affected router ID that is the router ID of an affected router, the distance to the affected router, and the maximum distance are registered. Similarly to the second embodiment, the candidate selection unit 103 sequentially selects an edge router 5 or an intermediate router 6 as an affected router one by one, calculates the distance to an edge router 5 and an intermediate router 6 downstream where the selected edge router 5 or intermediate router 6 is an affected router, and registers the distance in the distance information table 134 together with the affected router ID.

Reference sign Ga indicates the distance information table 134 when the candidate selection unit 103 selects the edge router (#1) 5 as the affected router. The candidate selection unit 103 registers a router ID “#1” as an affected router ID of the intermediate router (#A) 6, the intermediate router (#B) 6, and the intermediate router (#D) 6 downstream where the edge router (#1) 5 is an affected router, in addition to the edge router (#1) 5 itself. Furthermore, the candidate selection unit 103 registers the distance to the affected router together with the affected router ID. For example, the distance between the edge router (#1) 5 and the intermediate router (#D) 6 having the router ID “#D” is three hops, and thus the router ID “#1” and the distance “3” are registered.

Furthermore, the candidate selection unit 103 registers a maximum distance that is a maximum value of the distance for every router ID. At this stage, since only one distance is registered, that distance is the maximum distance.

Reference sign Gb indicates the distance information table 134 when the candidate selection unit 103 selects the edge router (#2) 5 as the affected router. The candidate selection unit 103 registers a router ID “#2” as an affected router ID of the intermediate router (#B) 6 and the intermediate router (#D) 6 downstream where the edge router (#2) 5 is an affected router, in addition to the edge router (#2) 5 itself. Furthermore, the candidate selection unit 103 registers the distance to the affected router together with the affected router ID. For example, the distance between the edge router (#2) 5 and the intermediate router (#D) 6 having the router ID “#D” is two hops, and thus the router ID “#1” and the distance “2” are registered.

Furthermore, the candidate selection unit 103 registers a maximum distance that is a maximum value of the distance for every router ID. For example, since the distances “3” and “2” are registered for the router ID “#D”, the maximum distance is “3”.

The candidate selection unit 103 sequentially selects the rest of the edge routers 5 and the intermediate routers 6 and performs processes similar to the above.

Reference sign Gc indicates the distance information table 134 after all of the edge routers 5 and the intermediate routers 6 have been selected. In the maximum distance, the maximum value of the distance between each edge router 5 and each intermediate router 6 corresponding to the router ID and the affected router is registered.

The candidate selection unit 103 selects the intermediate router (#C) 6 whose maximum value of the distance to the affected router is shortest from the distance information table 134 (see the dotted circle). Therefore, the setting processing unit 104 performs block setting on the intermediate router (#C) 6.

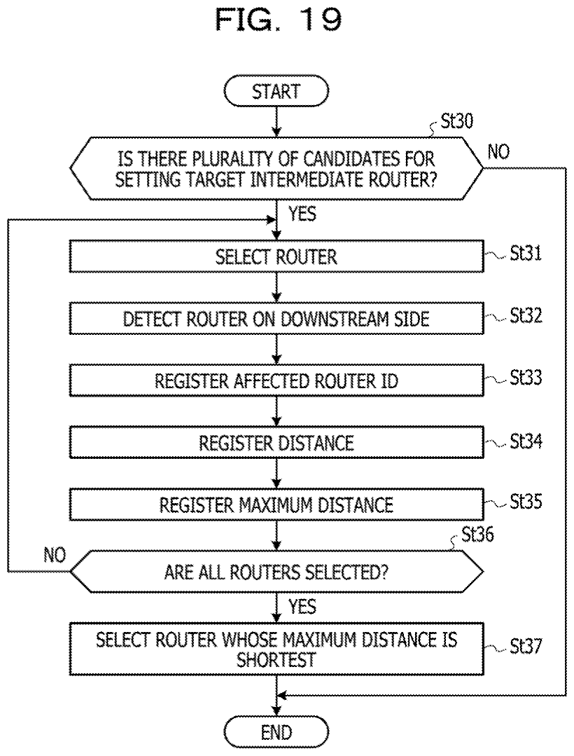

FIG. 19 is a flowchart illustrating another example of the process of selecting the setting target router. This process corresponds to the process of step St7 in FIG. 11.

The candidate selection unit 103 determines, based on the route DB 130, whether or not there is a plurality of intermediate routers 6 to which communication routes R of a plurality of flows of traffic from a part of the edge routers 5 merge as candidates for the setting target router (step St30). If there is only one candidate intermediate router 6 (No in step St30), the process ends.

If there is a plurality of intermediate routers 6 corresponding to candidates (Yes in step St30), the candidate selection unit 103 selects one of the edge routers 5 or the intermediate routers 6 as an affected router based on the route DB 130 (step St31). Next, the candidate selection unit 103 detects the edge router 5 and the intermediate router 6 downstream of the selected router based on the route DB 130 (step St32). Here, the edge router 5 and the intermediate router 6 downstream are routers where the selected router is an affected router.

Next, for the detected edge router 5 and intermediate router 6 downstream, the candidate selection unit 103 registers the router ID of the selected router as an affected router ID in the distance information table 134 (step St33). Then, the candidate selection unit 103 registers the distance to the selected affected router for the edge router 5 and the intermediate router 6 of downstream (step St34). Next, the candidate selection unit 103 registers the maximum value of registered distances as the maximum value of distance of the distance information table 134 (step St35).

Next, the candidate selection unit 103 determines whether or not all of the edge routers 5 and the intermediate routers 6 have been selected (step St36). If there is an unselected edge router 5 or intermediate router 6 (No in step St36), the respective processes in and after step St31 are executed again.

When all of the edge routers 5 and the intermediate routers 6 have been selected (Yes in step St36), the candidate selection unit 103 selects the intermediate router 6 whose maximum distance is shortest from the distance information table 134 as the setting target router (step St37). In this manner, the process of selecting a setting target router is executed.

As described above, when there are two or more intermediate routers 6 where communication routes R of a plurality of flows of traffic addressed to the attack target server 4 merge as candidates for the setting target router, the candidate selection unit 103 selects an intermediate router 6 whose maximum value of the distance to the affected router is shortest from among the intermediate routers 6.

Therefore, when attack traffic flows to the selected intermediate router 6, since the maximum distance from the affected router to the intermediate router 6 is short, it is possible to suppress the number of links where the band of other traffic is pressed by the attack traffic.

### Fourth Embodiment

In the first to third embodiments, the NW management server 1 selects one setting target router at a time and performs restriction setting on the setting target router, but the embodiment is not limited to this. Two setting target routers downstream of each edge router 5 may be selected at a time, and different types of restriction setting may be performed on these setting target routers.

In this case, regardless of which edge router 5 is the inflow source router, transfer of attack traffic may be restricted by restriction setting of one of the setting target routers. Thus, it is possible to reduce pressing by attack traffic of the band of other normal traffic until the inflow source router is identified.

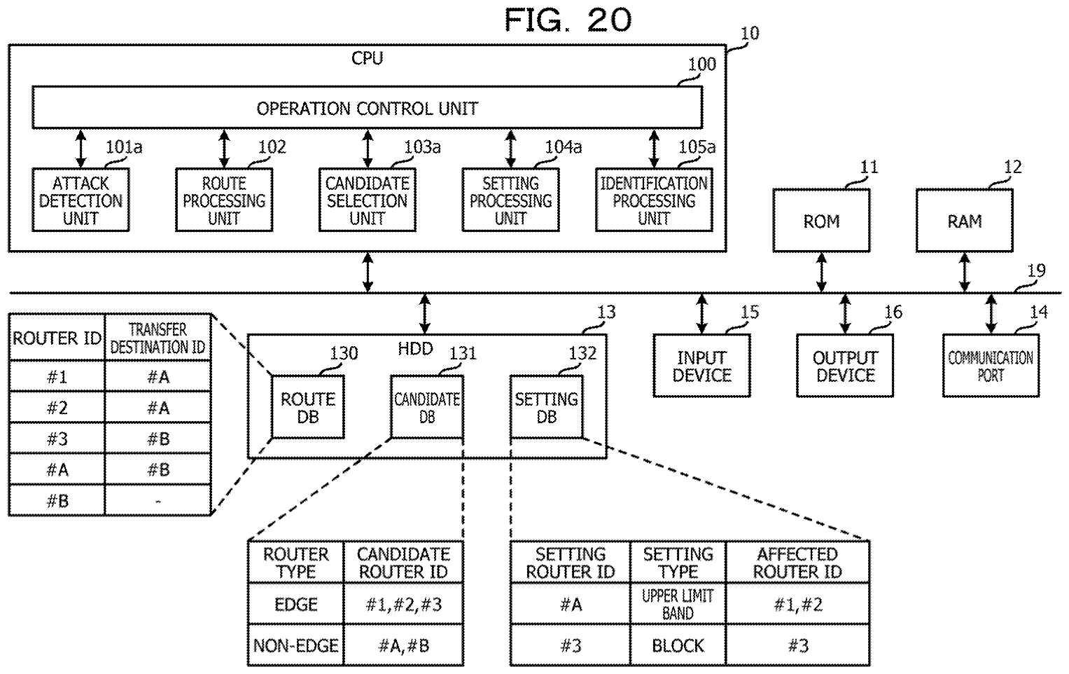

FIG. 20 is a configuration diagram illustrating a NW management server 1a according to a fourth embodiment in FIG. 20, components common to FIG. 8 are denoted by the same reference signs, and description thereof will be omitted. Note that the NW management server 1a is an example of a network management apparatus.

Upon reading the program from the ROM 11, the CPU 10 forms, as functions, an operation control unit 100, an attack detection unit 101a, a route processing unit 102, a candidate selection unit 103a, a setting processing unit 104a, and an identification processing unit 105a. The differences from the first to third embodiments will be described below. Note that the attack detection unit 101a is an example of a detection unit, and the candidate selection unit 103a is an example of selection. Furthermore, the setting processing unit 104a is an example of an instruction unit.

Furthermore, the operation control unit 100, the attack detection unit 101a, the route processing unit 102, the candidate selection unit 103a, the setting processing unit 104a, and the identification processing unit 105a may be circuits formed by hardware such as an FPGA or an ASIC for example.

Unlike the candidate selection unit 103, the candidate selection unit 103a selects two setting target routers. In the following description, the two setting target routers will be described as “first setting target router” and “second setting target router”, respectively. Note that the first setting target router is an example of a first router, and the second setting target router is an example of a second router.

The first setting target router is an example of a first router, and is an intermediate router 6 where communication routes R of a plurality of flows of traffic that a part of the edge routers 5 transfer to the attack target server 4 merge. The second setting target router is an example of a second router, and is one of rest of the edge routers 5 or is an intermediate router 6 upstream on a communication route R of traffic that rest of the edge routers 5 transfer to the attack target server 4 among the intermediate routers 6.

The candidate selection unit 103a selects the first setting target router and the second setting target router so that all the edge routers 5 are affected routers. The candidate selection unit 103a registers the first setting target router and the second setting target router in the setting DB 132. At this time, the candidate selection unit 103a sets different types of restriction setting on the first setting target router and the second setting target router.

In the following description, the restriction setting on the first setting target router will be described as “first setting”, and the restriction setting on the second setting target router will be described as “second setting”. The first setting is an example of a first unit, and the second setting is an example of a second unit.

Unlike the setting processing unit 104, the setting processing unit 104a performs the first setting and the second setting, which are different types of restriction setting, on the first setting target router and the second setting target router, respectively, based on the setting DB 132. Unlike the attack detection unit 101, the attack detection unit 101a detects changes in attack traffic in response to the first setting and the second setting. The attack detection unit 101a obtains, for example, attack information from the detection device 3, and distinguishes and detects changes in attack traffic in response to the first setting and the second setting based on the band of the attack traffic or the like indicated by the attack information.

Unlike the identification processing unit 105, the identification processing unit 105a narrows down candidates for the inflow source router according to which change is detected between a change in response to the first setting and a change in response to the second setting, instead of presence or absence of a change in the attack traffic. At this time, since each edge router 5 is an affected router of either the first setting target router or the second setting target router, transfer of the attack traffic is restricted regardless of which of the edge routers 5 the inflow source router is. Hereinafter, an operation example of the NW management server 1a will be described with an example of restriction setting.

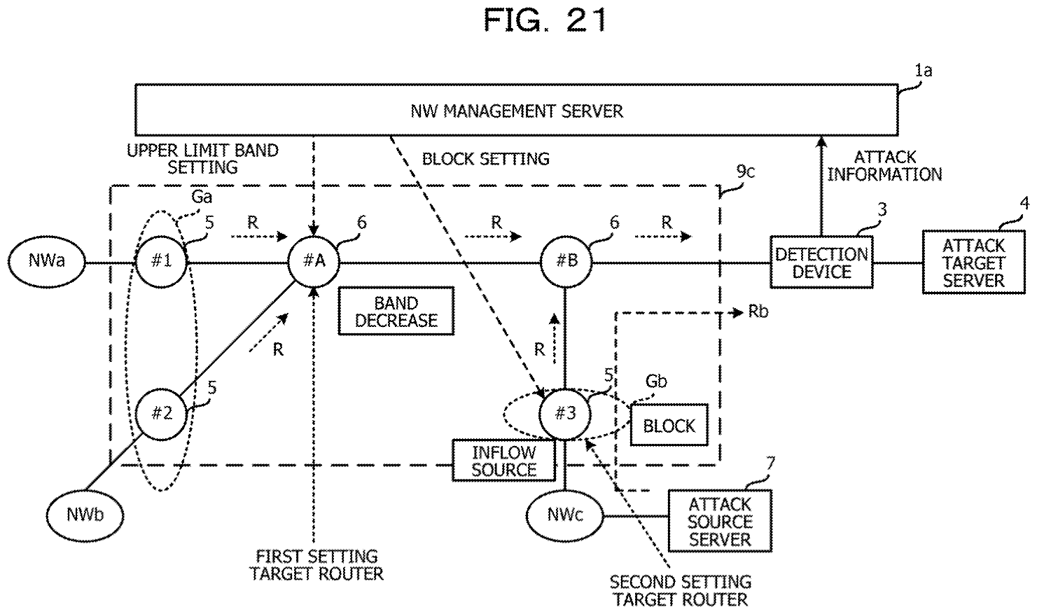

FIG. 21 is a diagram illustrating an example of the restriction setting in the fourth embodiment. In FIG. 21, components common to FIG. 4 are denoted by the same reference signs, and description thereof will be omitted.

The NW management server 1a manages a network 9c including a plurality of edge routers 5 and a plurality of intermediate routers 6. The network 9c includes an edge router (#1) 5 to an edge router (#3) 5, an intermediate router (#A) 6, and an intermediate router (#B) 6. The intermediate router (#A) 6 is adjacent to the intermediate router (#B) 6, the edge router (#1) 5, and the edge router (#2) 5, and the intermediate router (#B) 6 is adjacent to the intermediate router (#A) 6, the edge router (#3) 5, and the detection device 3.

The route processing unit 102 calculates communication routes R of traffic addressed to the attack target server 4 from route information obtained from each edge router 5 and each intermediate router 6, and registers the communication routes R in the route DB 130 as illustrated in FIG. 20. Furthermore, the candidate selection unit 103a registers the candidate DB 131.

The candidate selection unit 103a selects as the first setting target router the intermediate router (#A) 6 where the communication routes R of traffic addressed to the attack target server 4 that is transferred by the edge router (#1) 5 and the edge router (#2) 5 merge. Furthermore, the candidate selection unit 103a selects the edge router (#3) 5 as the second setting target router.

As illustrated in FIG. 20, the candidate selection unit 103a registers the identifiers “#A” and “#3” of the intermediate router (#A) 6 and the edge router (#3) 5 in the setting DB 132. Further, the candidate selection unit 103a registers the affected router IDs of the intermediate router (#A) 6 and the edge router (#3) 5. Furthermore, the candidate selection unit 103a registers “upper limit band” as the setting type of the intermediate router (#A) 6 and registers “block” as the setting type of the edge router (#3) 5.

The setting processing unit 104a performs upper limit band setting on the intermediate router (#A) 6 and performs block setting on the edge router (#3) 5 based on the setting DB 132. For example, the setting processing unit 104a instructs the first setting target router to restrict transfer of the attack traffic by the upper limit band setting, and instructs the second setting target router to restrict transfer of the attack traffic by the block setting. Accordingly, the respective edge routers 5 are divided into a group Ga of the edge router (#1) 5 and the edge router (#2) 5, and a group Gb of the remaining edge router (#3) 5. Note that the order of setting the intermediate router (#A) 6 and the edge router (#3) 5 is not limited.

The attack detection unit 101a obtains attack information from the detection device 3 so as to detect a change in the attack traffic due to the first setting and a change in the attack traffic due to the second setting. For example, the attack detection unit 101a detects that the band (amount of traffic) of the attack traffic has become zero as a change due to the block setting, and detects that the band of the attack traffic has decreased to a value according to the upper limit band as a change due to the upper limit band setting.

In this example, since the edge router (#3) 5 on which block setting is performed is the inflow source router, the attack traffic is blocked by the edge router (#3) 5. Thus, the attack detection unit 101a recognizes from the attack information that the band of the attack traffic has become zero and detects a change in the attack traffic in response to the block setting, but detects no change in the attack traffic in response to the upper limit band setting.

On the other hand, if the inflow source router is the edge router (#1) 5, the attack detection unit 101a recognizes from the attack information that the band of the attack traffic has decreased to the upper limit band, and detects a change in the attack traffic in response to the upper limit band setting but detects no change in the attack traffic in response to the block setting.

In this manner, the attack detection unit 101a may distinguish and detect a change in attack traffic in response to two types of restriction setting, for example, the first setting and the second setting. Thus, the identification processing unit 105a may determine which of the groups Ga and Gb the inflow source router is included in, according to the content of a change in the attack traffic.

If a change in the attack traffic in response to restriction by the first setting is detected and a change in the attack traffic in response to restriction by the second setting is not detected, the identification processing unit 105a identifies the inflow source router from the edge routers 5 of affected routers of the first setting target router. Furthermore, when no change in the attack traffic in response to restriction by the first setting is detected and a change in the attack traffic in response to restriction by the second setting is detected, the identification processing unit 105a identifies the inflow source router of the attack traffic from rest of the edge routers 5.

In this example, since a change in the attack traffic in response to the block setting is detected, and no change in the attack traffic in response to the upper limit band setting is detected, the identification processing unit 105a identifies the edge router (#3) 5 as the inflow source router. At this time, the identification processing unit 105a updates the route DB 130 and the candidate DB 131 similarly to the first embodiment.

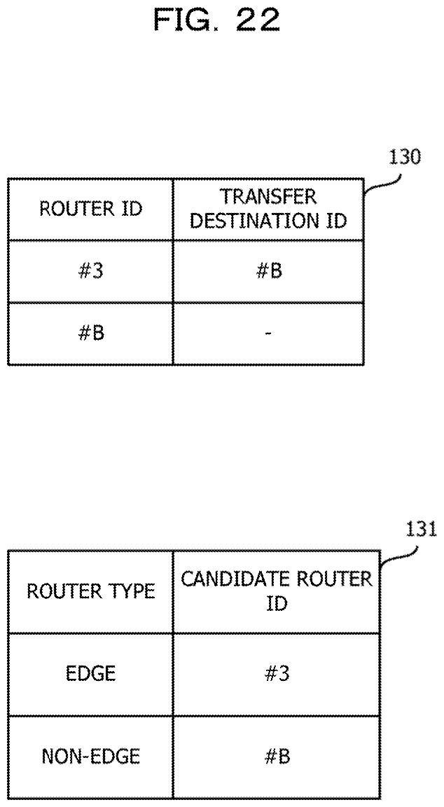

FIG. 22 is a diagram illustrating the route DB 130 and the candidate DB 131 after update. The identification processing unit 105a deletes the intermediate router (#A) 6 from the route DB 130 and the candidate DB 131 because no change in the attack traffic in response to the block setting on the intermediate router (#A) 6 is detected. Furthermore, the identification processing unit 105a also deletes the edge router (#1) 5 and the edge router (#2) 5 as the affected routers of the deleted intermediate router (#A) 6 from the route DB 130 and the candidate DB 131.

Thus, only “#3” is registered as the router ID of the edge router 5 in the updated candidate DB 131. Therefore, the identification processing unit 105a identifies the edge router (#3) 5 as the inflow source router.

Furthermore, if the inflow source router is the edge router (#1) 5, the identification processing unit 105a identifies the inflow source router from the remaining edge router (#1) 5 and edge router (#2) 5. In this case, the candidate selection unit 103a selects, for example, the edge router (#1) 5 and the edge router (#2) 5 as the first setting target router and the second setting target router, respectively.

Furthermore, the setting processing unit 104a performs upper limit band setting and block setting on the edge router (#1) 5 and the edge router (#2) 5, respectively. Since the inflow source router is the edge router (#1) 5, the attack detection unit 101a detects a change in the attack traffic in response to the upper limit band setting. Thus, the identification processing unit 105a identifies the edge router (#1) 5 as the inflow source router.

Next, a process of selecting the first setting target router and the second setting target router will be described.

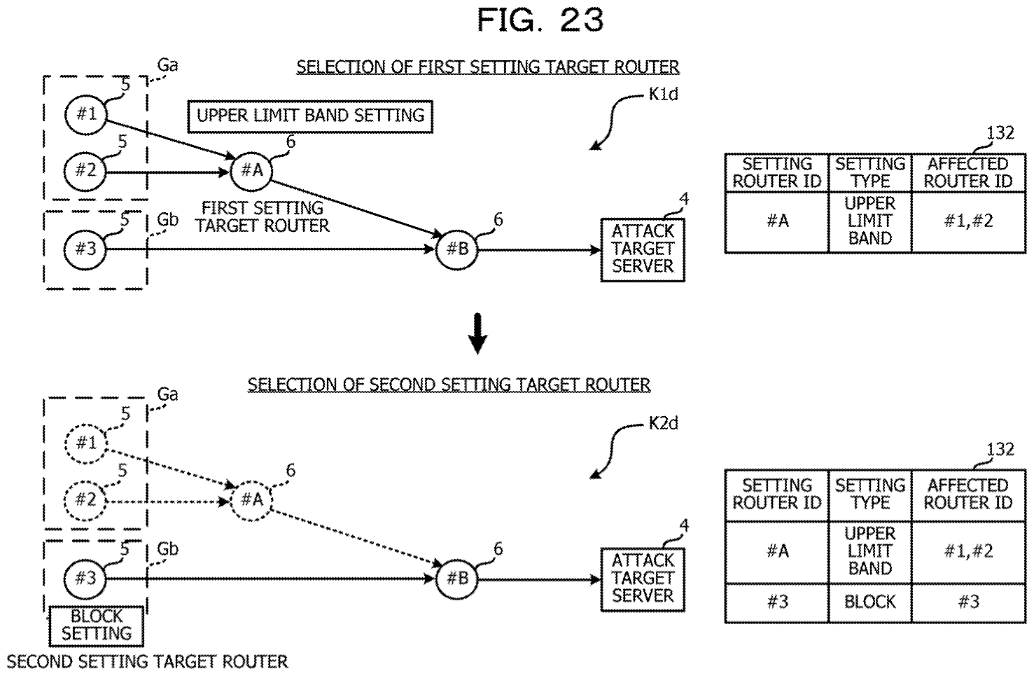

FIG. 23 is a diagram illustrating an example of a process of selecting the first setting target router and the second setting target router. Reference sign K1d indicates a tree structure of communication routes R described in the route DB 130 when the first setting target router is selected, and reference sign K2d indicates a tree structure of communication routes R described in the route DB 130 when the second setting target router is selected.

Based on the tree structure of all the communication routes R indicated by reference sign K1d, the candidate selection unit 103a selects as the first setting target router the intermediate router (#A) 6 where communication routes R of traffic addressed to the attack target server 4 that is transferred by a part of edge routers, the edge router (#1) 5 and the edge router (#2) 5, merge. The candidate selection unit 103a detects the edge router (#1) 5 and the edge router (#2) 5 downstream of the intermediate router (#A) 6 as affected routers.

The candidate selection unit 103a registers a router ID “#A” in the setting router ID of the setting DB 132, and sets router IDs “#1” and “#2” in the affected router ID corresponding to the setting router ID “#A”. Furthermore, the candidate selection unit 103a registers “upper limit band” in the setting type corresponding to the setting router ID “#A”. Note that “block” may be registered as the setting type.

Furthermore, as indicated by reference sign K2d, based on a tree structure that excludes the intermediate router (#A) 6 as the first setting target router and the edge router (#1) 5 and the edge router (#2) 5 which are affected routers thereof from the entire tree structure, the candidate selection unit 103a selects the remaining edge router (#3) 5 as the first setting target router. Note that, as described later, the candidate selection unit 103a may select the intermediate router (#B) 6 upstream on the communication route R of the traffic transferred by the remaining edge router (#3) 5 as the second setting target router. The candidate selection unit 103a detects the edge router (#3) 5 itself as an affected router.

The candidate selection unit 103a additionally registers a router ID “#3” in the setting router ID of the setting DB 132, and additionally sets the router ID “#3” in the affected router ID corresponding to the setting router ID “#3”. Furthermore, the candidate selection unit 103a registers “block” as the setting type corresponding to the setting router ID “#3”. Note that “upper limit band” may be registered as the setting type.

In the above example, the case where the upper limit band setting is performed on the intermediate router (#A) 6 and the block setting is performed on the edge router (#3) 5 has been described. However, upper limit band setting with different upper limit values may be performed on the intermediate router (#A) 6 and the edge router (#3) 5. Accordingly, the intermediate router (#A) 6 and the edge router (#3) 5 cause the band of the attack traffic to be equal to or less than the different upper limit values, and thus the detection device 3 may continue monitoring of behaviors of the attack traffic until the inflow source router is identified.

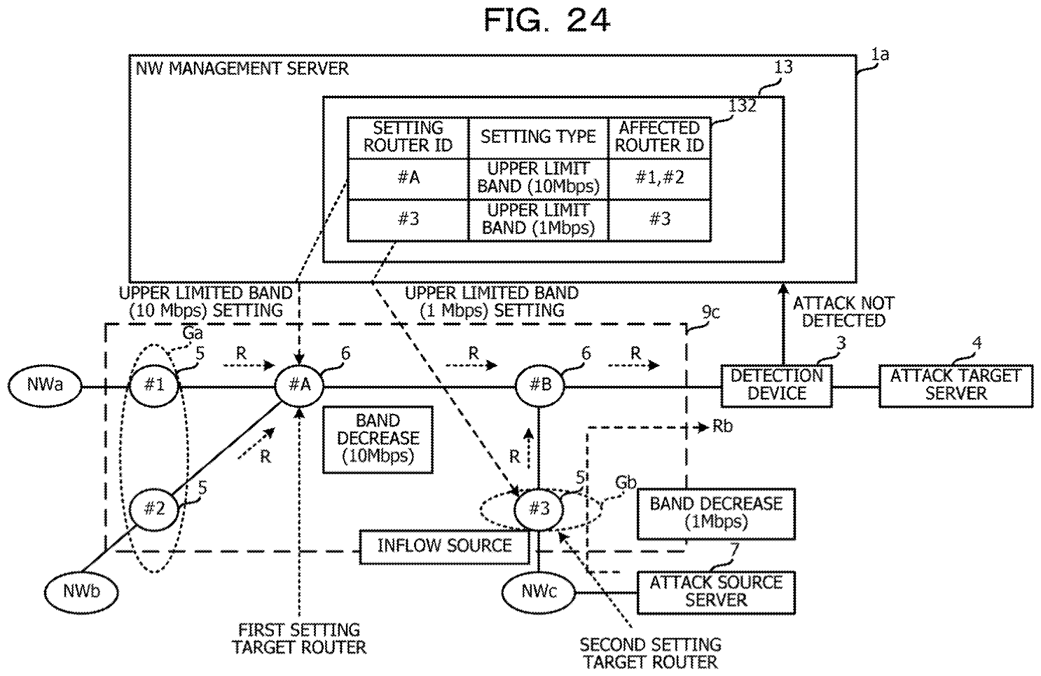

FIG. 24 is a diagram illustrating an example of upper limit band setting in which upper limit values are different from each other. In FIG. 24, components common to FIG. 4 are denoted by the same reference signs, and description thereof will be omitted.

The candidate selection unit 103a registers upper limit band setting with an upper limit value of ten (Mbps) as restriction setting of the intermediate router (#A) 6 in the setting DB 132, and registers upper limit band setting with an upper limit value of one (Mbps) as restriction setting of the edge router (#3) 5 in the setting DB 132. Note that there is no restriction on the upper limit value.

The setting processing unit 104a performs the upper limit band setting with an upper limit value of 10 (Mbps) on the intermediate router (#A) 6 based on the setting DB 132, and performs the upper limit band setting with an upper limit value of 1 (Mbps) on the edge router (#3) 5. The attack detection unit 101a obtains the band of the attack traffic from the attack information, and distinguishes and detects a change in the attack traffic in response to the upper limit band setting with an upper limit value of ten (Mbps) and a change in the attack traffic in response to the upper limit band setting with an upper limit value of one (Mbps) based on the band of the attack traffic.

The identification processing unit 105a identifies the inflow source router from one of the edge router (#1) 5 and the edge router (#2) 5 of the group Ga, or the edge router (#3) 5 of the group Gb according to a detection result of a change in the attack traffic.

In this manner, the candidate selection unit 103a uses the upper limit band setting for causing the band of the attack traffic to be equal to or less than the upper limit values different from each other as the first setting and the second setting, and thus the attack traffic continues to flow without being blocked regardless of which edge router 5 the inflow source router is. Thus, the detection device 3 may continue monitoring behaviors of the attack traffic until the inflow source router is identified.

Next, a flow of processing by the NW management server 1a will be described.

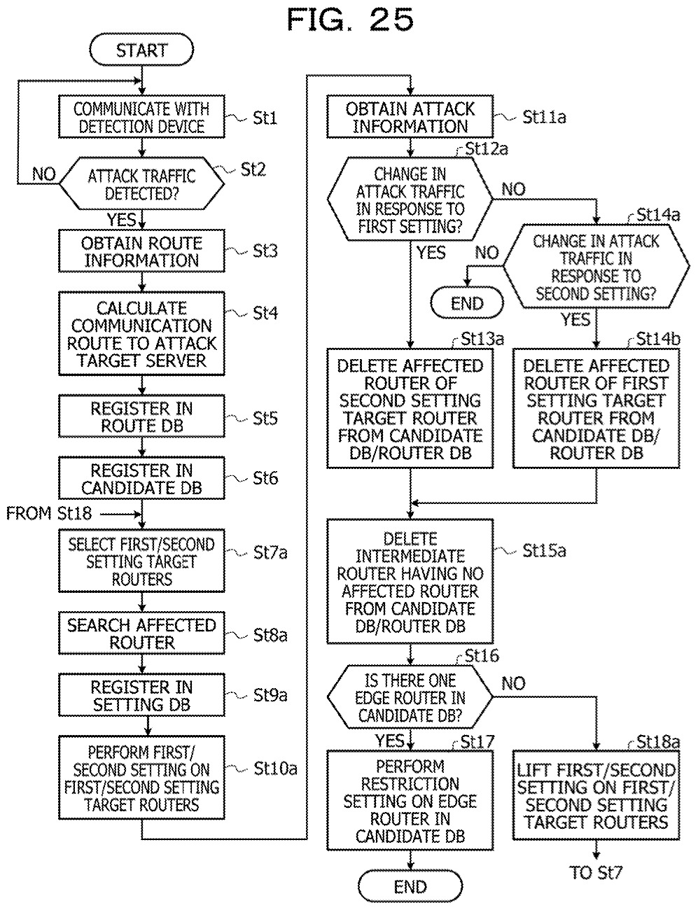

FIG. 25 is a flowchart illustrating another example of processing by the NW management server 1a. In FIG. 25, processes common to FIG. 11 are denoted by the same reference signs, and description thereof will be omitted. Note that this processing is an example of a network management program and a network management method.

After a process in step St6, the candidate selection unit 103a selects respective router IDs of the first setting target router and the second setting target router from the candidate router IDs in the candidate DB 131 (step St7a). The candidate selection unit 103 selects respective router IDs of the new first setting target router and second setting target router every time the inflow source router is narrowed down.

Next, based on the route DB 130, the candidate selection unit 103a searches for affected routers of the first setting target router and the second setting target router (step St8a). The candidate selection unit 103a searches for the edge routers 5 downstream on the communication route R as the affected router for the intermediate router (#A) 6, which is the first setting target router, and searches for the edge router 5 itself as an affected router for the edge router 5 (#3) of the second setting target router.

Next, the candidate selection unit 103a registers the router IDs of the setting target routers and the router IDs of the affected routers as the setting router IDs and the affected router IDs in the setting DB 132 (step St9a). Furthermore, the candidate selection unit 103 determines types of first setting and second setting, and registers “block” or “upper limit band setting” by every upper limit value as the setting type of the setting DB 132.

Next, the setting processing unit 104a performs the first setting and the second setting as restriction setting on the first setting target router and the second setting target router, respectively, according to the setting DB 132 (step St10a). The first setting target router and the second setting target router restrict the attack traffic by setting of an ACL, a policer, or a shaper according to an instruction by the setting processing unit 104a.

Next, the attack detection unit 101a obtains attack information from the detection device 3 in order to determine a change in the attack traffic (step St11a). Next, the attack detection unit 101a determines presence or absence of a change in response to the first setting based on a band value of the attack traffic included in the attack information (step St12a).

When a change in the attack traffic in response to the first setting is detected (Yes in step St12a), the identification processing unit 105a deletes the router ID of the affected router of the second setting target router registered in the setting DB 132 from the candidate DB 131 and the route DB 130 (step St13a). Accordingly, the edge router 5 which is the affected router of the second setting target router is excluded from the candidates for the inflow source router.

Furthermore, when no change in the attack traffic in response to the first setting is detected (No in step St12a), the attack detection unit 101a determines presence or absence of a change in response to the second setting based on the band value of the attack traffic included in the attack information (step St14a). When no change in the attack traffic in response to the second setting is detected (No in step St14a), the process ends because the attack traffic may have already stopped.

When a change in the attack traffic in response to the second setting is detected (Yes in step St14a), the identification processing unit 105a deletes the router ID of the affected router of the first setting target router registered in the setting DB 132 from the candidate DB 131 and the route DB 130 (step St14b). Accordingly, the edge router 5 that is the affected router of the first setting target router is excluded from the candidates for the inflow source router.

Next, the identification processing unit 105a searches the route DB 130 for an intermediate router 6 having no affected router due to the above deletion, and deletes the router ID thereof from the candidate DB 131 and the route DB 130 (step St15a). Note that if there is no intermediate router 6 corresponding to the above, the deletion is not executed.

Thereafter, if there is a plurality of edge routers 5 registered in the candidate DB 131 (No in step St16), the setting processing unit 104a lifts the first setting on the first setting target router and the second setting on the second setting target router (step St18a). Thus, the candidate selection unit 103a may select a new first setting target router and a new second setting target router from the edge routers 5 registered in the candidate DB 131. Thereafter, the respective processes in and after step St7a are executed again. Thus, the NW management server 1a executes the processing.

As described above, the candidate selection unit 103a further selects the second setting target router from rest of the edge routers excluding the affected routers of the first setting target router from all the edge routers 5 and from the intermediate routers 6 upstream on the communication routes R of traffic transferred by the rest of the edge routers to the attack target server 4. The setting processing unit 104a instructs the first setting target router to restrict transfer of the attack traffic by the first setting, and instructs the second setting target router to restrict transfer of the attack traffic by the second setting.

The attack detection unit 101a detects a change in the attack traffic in response to the restriction by the first setting and a change in the attack traffic in response to the restriction by the second setting. When a change in the attack traffic in response to the restriction by the first setting is detected and no change in the attack traffic in response to the restriction by the second setting is detected, the identification processing unit 105a identifies the inflow source router from the affected routers of the first setting target router. Furthermore, when a change in the attack traffic in response to the restriction by the first setting is not detected and a change in the attack traffic in response to the restriction by the second setting is detected, the identification processing unit 105a identifies the inflow source router from the rest of the edge routers 5.

Regardless of which edge router 5 the inflow source router is, transfer of the attack traffic may be restricted by the first setting on the first setting target router or the second setting on the second setting target router. Thus, it is possible to reduce pressing by attack traffic of the band of other normal traffic until the inflow source router is identified.

### Fifth Embodiment

In the fourth embodiment, since the first setting and the second setting different from each other are performed on the first setting target router and the second setting target router, it may not be possible to distinguish and detect changes in the attack traffic due to the first setting and the second setting depending on the positional relationship of the first setting target router and the second setting target router on the communication routes R of the attack traffic.

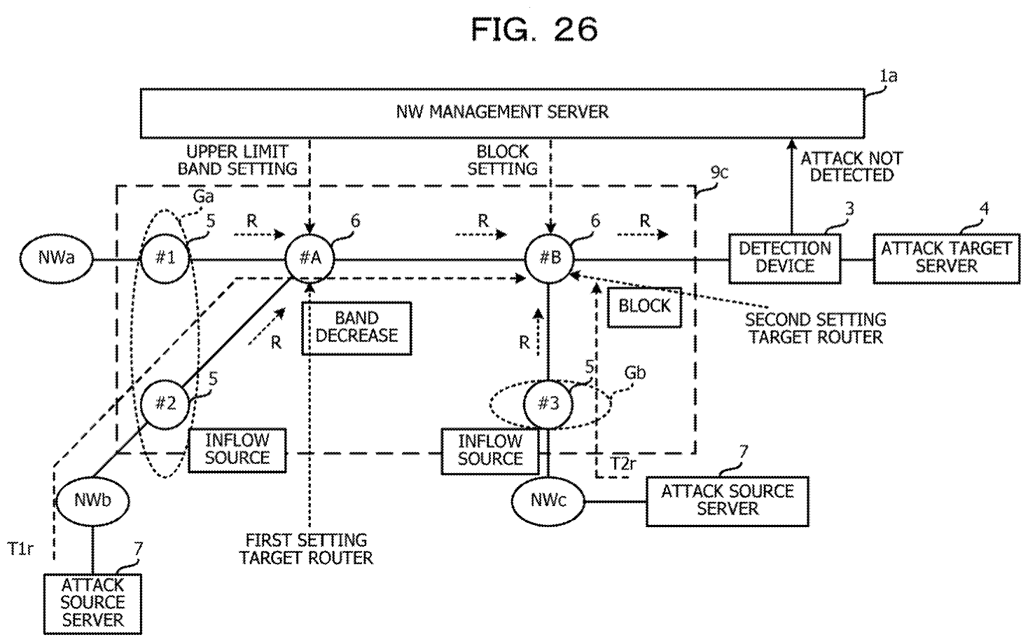

FIG. 26 is a diagram illustrating an example in which it is not possible to distinguish and detect influences of the first setting and the second setting. In FIG. 26, components common to FIG. 24 are denoted by the same reference signs, and description thereof will be omitted. Note that both of a case where the inflow source router is the edge router (#2) 5 and a case where the inflow source router is the edge router (#3) 5 are illustrated.

In this example, it is assumed that the intermediate router (#A) 6 is the first setting target router and the intermediate router (#B) 6 is the second setting target router. For example, the NW management server 1a performs upper limit band setting on the intermediate router (#A) 6, and performs block setting on the intermediate router (#B) 6.

When the inflow source router is the edge router (#2) 5, attack traffic T1r is reduced in band at the intermediate router (#A) 6 where the traffic passes first, and is blocked at the intermediate router (#B) 6 downstream thereof. On the other hand, also when the inflow source router is the edge router (#3) 5, attack traffic T2r is blocked at the intermediate router (#B) 6.

Thus, the detection device 3 is not capable of detecting the attack traffic T1r and T2r either when the inflow source router is the edge router (#2) 5 or when it is the edge router (#3) 5. Therefore, the detection device 3 is not capable of detecting a decrease in the band of the attack traffic T1r in response to the upper limit band setting, and is not capable of distinguishing and detecting changes in the attack traffic due to the upper limit band setting and the block setting.

Accordingly, the candidate selection unit 103a of the NW management server 1a selects the first setting target router and the second setting target router based on arrangement information for restricting arrangement of the first setting target router and the second setting target router on communication routes R.

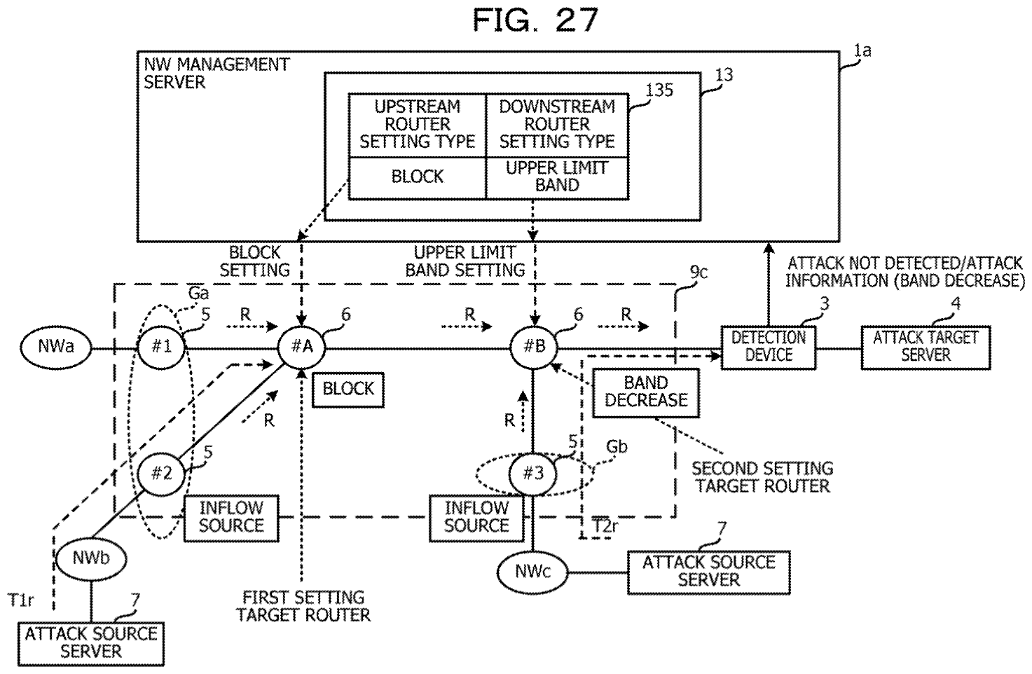

FIG. 27 is a diagram illustrating an example of restriction setting in the fifth embodiment. In FIG. 27, components common to FIG. 26 are denoted by the same reference signs, and description thereof will be omitted.

Arrangement information 135 is stored in an HDD 13 of the NW management server 1a in advance. Note that the HDD 13 is an example of a storage unit.

In the arrangement information 135, a combination of a setting type of the upstream router and a setting type of the downstream router on a communication route R, out of the first setting target router and the second setting target router, is registered. This combination of setting types is a combination that allows the detection device 3 to distinguish and detect changes in attack traffic due to upper limit band setting and block setting.

As described with reference to FIG. 26, when the upper limit band setting is performed on the intermediate router (#A) 6 upstream and the block setting is performed on the intermediate router (#B) 6 downstream, it is not possible for the detection device 3 to distinguish and detect changes in the attack traffic due to the upper limit band setting and the block setting. Thus, the arrangement information 135 indicates that the setting type of the router upstream is set to the block setting, and the setting type of the router downstream is set to the upper limit band setting.

For example, when the block setting and the upper limit band setting are respectively performed on the first setting target router and the second setting target router, the arrangement information 135 indicates that the router upstream is the first setting target router, and the router downstream is the second setting target router. Namely, the arrangement information 135 indicates which of the first setting target router and the second setting target router is arranged upstream on the communication route R.

After selecting the first setting target router and the second setting target router, the candidate selection unit 103a determines validity of selection of the first setting target router and the second setting target router based on the arrangement information 135. For example, the candidate selection unit 103a determines whether or not arrangement of the first setting target router and the second setting target router selected is in accordance with the arrangement information 135. The candidate selection unit 103a repeats the selection until it is determined that the selection of the first setting target router and the second setting target router is valid.

Therefore, based on the arrangement information 135, the candidate selection unit 103a selects the intermediate router (#A) 6 as the first setting target router for performing the block setting, and selects the intermediate router (#B) 6 as the second setting target router for performing the upper limit band setting. Furthermore, the setting processing unit 104a performs the block setting on the intermediate router (#A) 6, and performs the upper limit band setting on the intermediate router (#8) 6.

When the inflow source router is the edge router (#2) 5, the attack traffic T1r is blocked at the intermediate router (#A) 6. In this case, the detection device 3 does not detect the attack traffic T1r.

On the other hand, when the inflow source router is the edge router (#3) 5, the band of the attack traffic T2r decreases at the intermediate router (#B) 6. In this case, the detection device 3 may detect that the band of the attack traffic T2r has decreased to be equal to or less than the upper limit value.

Therefore, unlike the case of FIG. 26, the detection device 3 may distinguish and detect changes in attack traffic due to the upper limit band setting and the block setting.

Next, a process of determining validity of selection of the first setting target router and the second setting target router will be described.

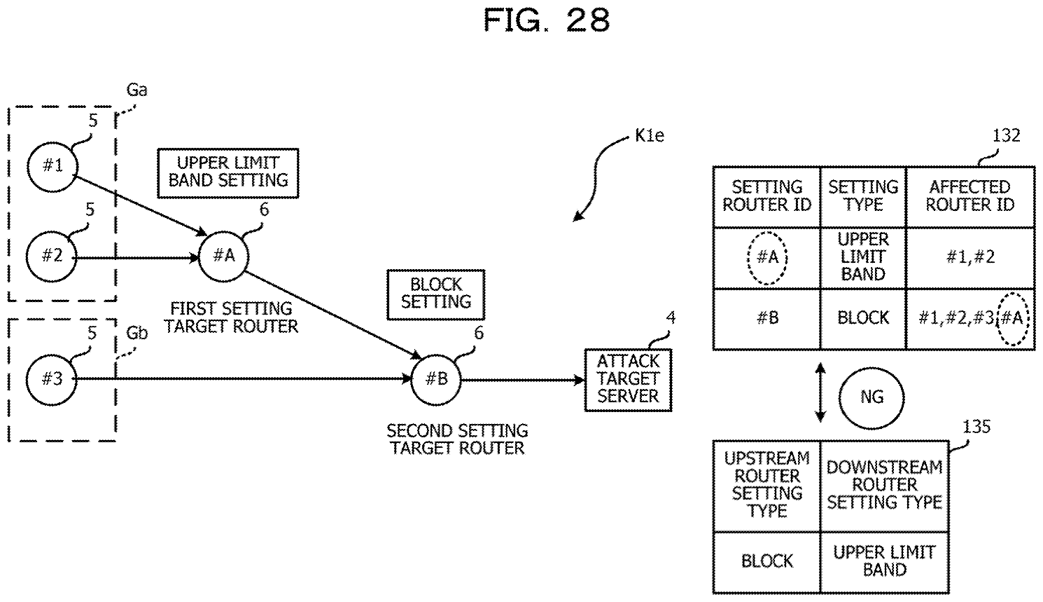

FIG. 28 is a diagram illustrating an example of a case where selection of the first setting target router and the second setting target router is not valid. Reference sign K1e indicates a tree structure of communication routes R described in the route DB 130. In this example, upper limit band setting is performed on the first setting target router, and block setting is performed on the second setting target router.

The candidate selection unit 103a selects the intermediate router (#A) 6 as the first setting target router, and selects the intermediate router (#B) 6 as the second setting target router (see reference sign K1e), as in the example of FIG. 26. The candidate selection unit 103a searches for the affected router IDs “#1” and “#2” of the first setting target router, and searches for the affected router IDs “#1” to “#3” and “#A” of the second setting target router. The candidate selection unit 103a registers the setting router ID, the setting type, and the affected router IDs in the setting DB 132 for each of the first setting target router and the second setting target router.

Next, the candidate selection unit 103a refers to the arrangement information 135. The arrangement information 135 indicates that, similarly to the example described above, the second setting target router whose setting type is “block” is arranged upstream of the first setting target router whose setting type is “upper limit band”.

The candidate selection unit 103a recognizes that the intermediate router (#A) 6 as the first setting target router is arranged upstream of the intermediate router (#B) 6 as the second setting target router because the affected router ID of the setting router ID “#B” in the setting DB 132 includes another setting router ID “#A” (see the dotted circles). Thus, the candidate selection unit 103a determines that the arrangement of the first setting target router and the second setting target router is not in accordance with the arrangement information 135, and that the selection is not valid (see “NG”).

Thus, the candidate selection unit 103a again selects the first setting target router and the second setting target router, as described below.

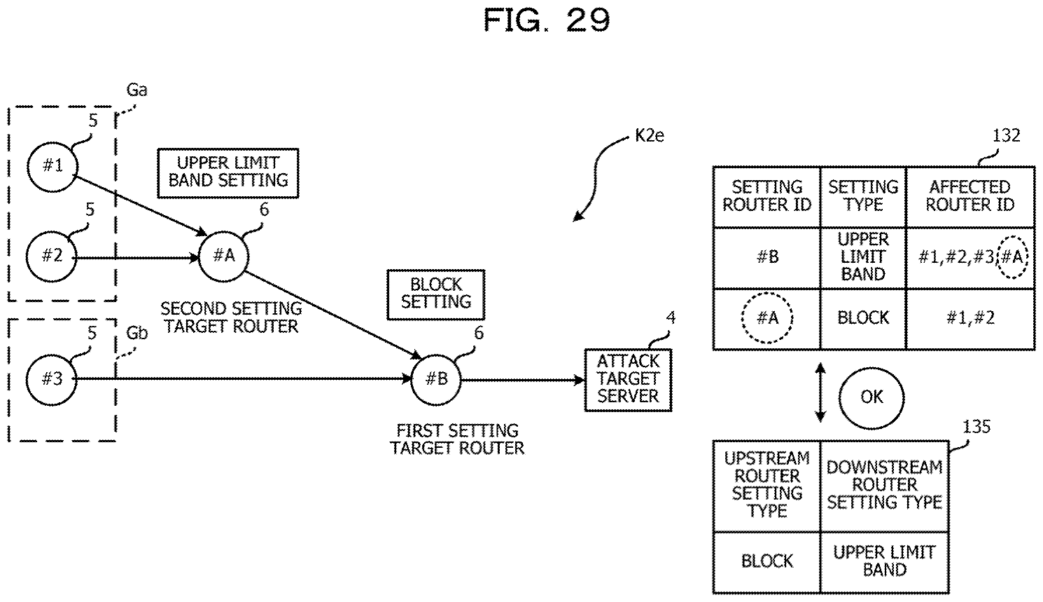

FIG. 29 is a diagram illustrating an example of a case where selection of the first setting target router and the second setting target router is valid. Reference sign K2e indicates a tree structure of communication routes R described in the route DB 130.

Unlike the example of FIG. 28, the candidate selection unit 103a selects the intermediate router (#B) 6 as the first setting target router, and selects the intermediate router (#A) 6 as the second setting target router (see reference sign K2e). The candidate selection unit 103a searches for affected router IDs “#1” to “#3” and “#A” of the first setting target router, and searches for affected router IDs “#1” and “#2” of the second setting target router. The candidate selection unit 103a registers the setting router ID, the setting type, and the affected router IDs in the setting DB 132 for each of the first setting target router and the second setting target router.

Next, the candidate selection unit 103a refers to the arrangement information 135. The candidate selection unit 103a recognizes that the intermediate router (#A) 6 as the first setting target router is arranged downstream of the intermediate router (#B) 6 as the second setting target router because the affected router ID of the setting router ID “#B” In the setting DB 132 includes another setting router ID “#A” (see the dotted circles). Thus, the candidate selection unit 103a determines that the arrangement of the first setting target router and the second setting target router is in accordance with the arrangement information 135, and that the selection is valid (see “OK”).

In this manner, the process of determining validity of selection of the first setting target router and the second setting target router is performed.

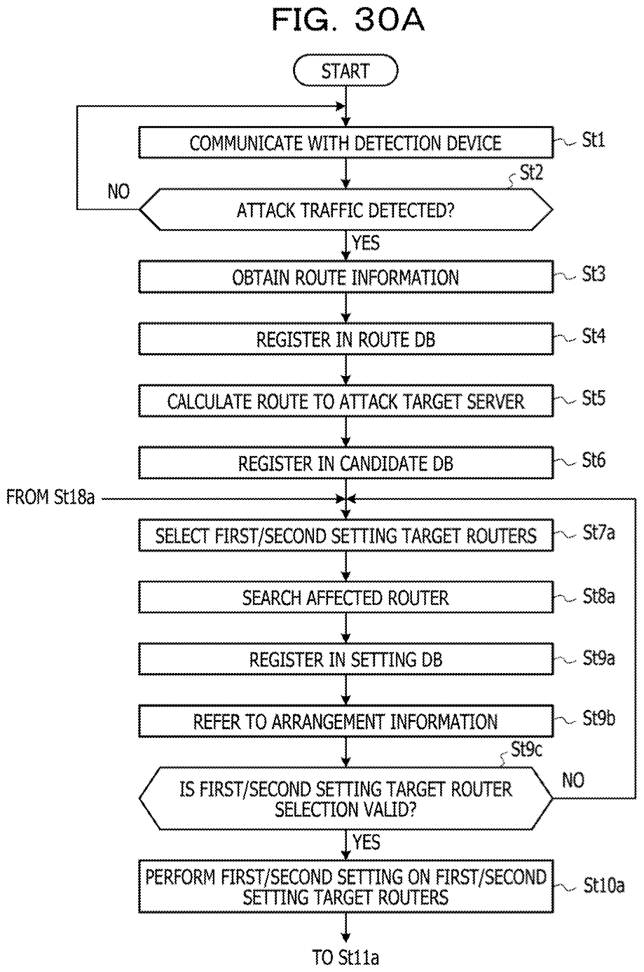

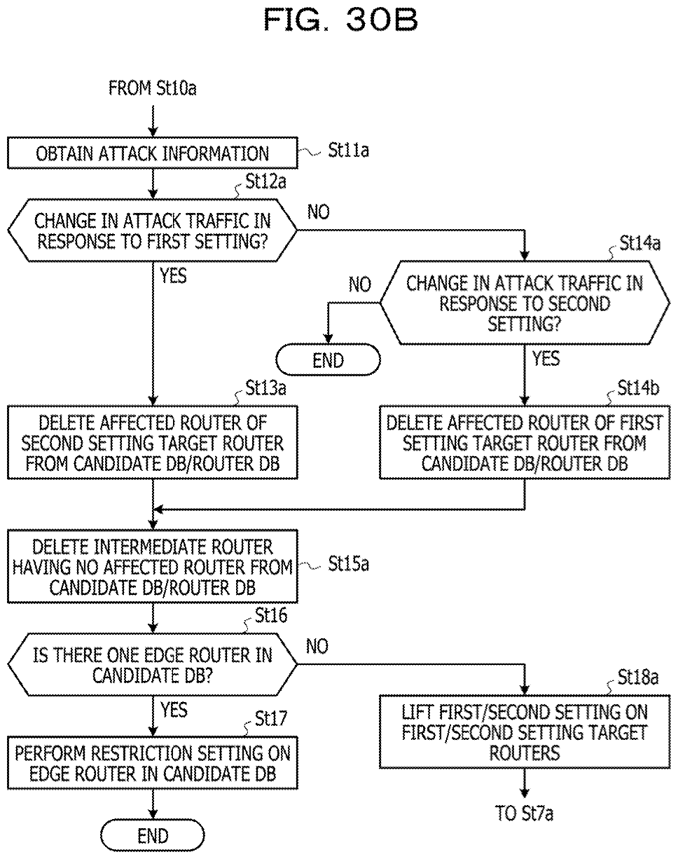

FIG. 30A to 308 is a flowchart illustrating another example of processing by the NW management server 1a. In FIG. 30A to 30B, processes common to FIG. 25 are denoted by the same reference signs, and description thereof will be omitted. Note that this processing is an example of a network management program and a network management method.

After registering the setting DB 132 (step St9a), the candidate selection unit 103a refers to the arrangement information 135 based on the setting DB 132 (step St9b). Next, the candidate selection unit 103a determines whether or not selection of the first setting target router and the second setting target router is valid according to the arrangement information 135 (step St9c).

At this time, as described above, the candidate selection unit 103a compares the setting router ID and the affected router ID in the setting DB 132, so as to determine which of the first setting target router and the second setting target router is arranged upstream or downstream. Then, the candidate selection unit 103a determines whether the arrangement of the first setting target router and the second setting target router is in accordance with the arrangement information 135.

If the selection of the first setting target router and the second setting target router is valid (Yes in step St9c), the setting processing unit 104a performs first setting and second setting on the first setting target router and the second setting target router, respectively (step St10a). Thereafter, respective processes in and after step St11a are executed.

Furthermore, when the selection of the first setting target router and the second setting target router is not valid (No in step St9c), the respective processes in and after step St7a are executed again. Thus, the candidate selection unit 103a repeats the selection until the selection of the first setting target router and the second setting target router becomes valid. Thus, the NW management server 1a executes the processing.

As described above, the HDD 13 stores the arrangement information 135 indicating which of the first setting target router and the second setting target router is arranged upstream on the communication routes R. The candidate selection unit 103a selects the first setting target router and the second setting target router based on the arrangement information 135.

Thus, by setting the arrangement information 135 so that changes in attack traffic due to the first setting and the second setting are distinguished, the identification processing unit 105a may identify the inflow source router based on a change in the attack traffic.

Note that, although the upper limit band setting and the block setting are given as the first setting and the second setting in this example, the first setting and the second setting may be upper limit band setting with upper limit values different from each other as in the example of FIG. 24. Also in this case, the candidate selection unit 103a selects the first setting target router and the second setting target router based on the arrangement information 135, and thereby it is possible for the attack detection unit 101a to distinguish and detect changes in attack traffic in response to the first setting and the second setting.

Note that the processing functions described above may be implemented by a computer. In that case, there is provided a program that describes processing content of functions which a processing device may have. By executing the program on a computer, the above processing functions are implemented on the computer. The program that describes the processing content may be recorded in a computer-readable reading medium (however, carrier waves are excluded).

In the case of distributing the program, for example, the program is sold in a form of a portable recording medium such as a digital versatile disc (DVD) or a compact disc read only memory (CD-ROM) in which the program is recorded. Furthermore, it is possible to store the program in a storage device of a server computer and transfer the program from the server computer to another computer through a network.

The computer which executes the program stores, for example, the program recorded in the portable reading medium or the program transferred from the server computer in a storage device of the computer. Then, the computer reads the program from its own storage device and executes a process according to the program. Note that the computer may also read the program directly from the portable recording medium and execute the process in accordance with the program. Furthermore, the computer may also sequentially execute processing according to the received program every time when the program is transferred from the server computer.

The embodiments described above are preferred examples. However, the present embodiment is not limited to this, and a variety of modifications can be made without departing from the scope of the present embodiment.

For example, the NW management server 1 further divides the group Gb included a plurality of edge router 5 in to a plurality of groups (for example, a first group Gb and second group Gb) as same method after the NW management server 1 divided all the edge routers 5 into a group Ga and the group Gb and specified the group Gb as the inflow source router. Thereafter, the NW management server 1 may specify the first group Gb including the inflow source router among the plurality of groups. Further, the NW management server 1 may repeat this processing (division and specific processing) and narrow down the candidates of the inflow source router to a predetermined number or less.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network management apparatus that manages a network including a plurality of edge routers and a plurality of intermediate routers connected among the plurality of edge routers, the network management apparatus comprising:
a memory; and
a processor coupled to memory and configured to:
calculate a communication route of traffic that each of the plurality of edge routers transfers to an attack target device that is attacked from outside the network;
select, from the plurality of intermediate routers, a first router where the communication routes of a plurality of flows of traffic that a part of the plurality of edge routers transfer to the attack target device merge;
instruct the first router to restrict transfer of the traffic of the attack;
detect a change in traffic of the attack in response to a restriction on transfer of the traffic of the attack; and
identify an edge router of an inflow source from the part of the plurality of edge routers when a change in the traffic of the attack is detected, or identify an edge router of the inflow source of the traffic of the attack from rest of the plurality of edge routers when no change in the traffic of the attack is detected.

2. The network management apparatus according to claim 1, wherein
when the plurality of intermediate routers includes two or more intermediate routers as candidates for the first router, the processor selects, from the two or more intermediate routers, an intermediate router whose number of edge routers included in a part of the plurality of edge routers is closest to half of a total number of the plurality of edge routers.

3. The network management apparatus according to claim 1, wherein
when the plurality of intermediate routers includes two or more intermediate routers as candidates for the first router, the processor selects, from the two or more intermediate routers, an intermediate router whose maximum value of distance to a part of the plurality of edge routers is shortest.

4. The network management apparatus according to claim 1, wherein
the processor further configured to:
selects, from rest of the plurality of edge routers and the plurality of intermediate routers, a second router from intermediate routers upstream on the communication routes of traffic that the rest of the plurality of edge routers transfer to the attack target device,
instructs the first router to restrict transfer of the traffic of the attack by a first unit and instructs the second router to restrict transfer of the traffic of the attack by a second unit,
detects each of a change in the traffic of the attack in response to the restriction by the first unit and a change in the traffic of the attack in response to the restriction by the second unit, and
identifies an edge router of the inflow source from the part of the plurality of edge routers when a change in the traffic of the attack in response to the restriction by the first unit is detected and a change in the traffic of the attack in response to the restriction by the second unit is not detected, or identifies the edge router of the inflow source from rest of the plurality of edge routers when a change in the traffic of the attack in response to the restriction by the first unit is not detected and a change in the traffic of the attack in response to the restriction by the second unit is detected.

5. The network management apparatus according to claim 4, wherein
the first unit and the second unit cause a band of the traffic of the attack to be equal to or less than upper limit values different from each other.

6. The network management apparatus according to claim 4, wherein
the memory stores arrangement information indicating which of the first router and the second router is arranged upstream on the communication route, and
the processor selects the first router and the second router based on the arrangement information.

7. A network management method that manages a network including a plurality of edge routers and a plurality of intermediate routers connected among the plurality of edge routers, the network management method comprising, by a computer:
calculating a communication route of traffic that each of the plurality of edge routers transfers to an attack target device that is attacked from outside the network;
selecting, from the plurality of intermediate routers, a first router where the communication routes of a plurality of flows of traffic that a part of the plurality of edge routers transfer to the attack target device merge;
instructing the first router to restrict transfer of the traffic of the attack;
detecting a change in traffic of the attack in response to a restriction on transfer of the traffic of the attack; and
identifying an edge router of an inflow source of the attack from the part of the plurality of edge routers when a change in the traffic of the attack is detected, or identify an edge router of the inflow source of the attack from rest of the plurality of edge routers when no change in the traffic of the attack is detected.
